(19) United States
(12) Patent Application Publication
(10) Pub. No.: US 2025/0060937 A1
(43) Pub. Date: Feb. 20, 2025

(54) SYSTEM AND METHOD FOR TARGET DETECTION, TERMINAL DEVICE AND NON-TRANSITORY COMPUTER-READABLE STORAGE MEDIUM

(71) Applicant: CHINA GREAT WALL TECHNOLOGY GROUP CO., LTD., Shenzhen (CN)

(72) Inventors: Hongbin TU, Shenzhen, Guangdong (CN); Lufeng ZHANG, Shenzhen, Guangdong (CN); Xuan LI, Shenzhen, Guangdong (CN); Cheng LIAO, Shenzhen, Guangdong (CN); Guang YI, Shenzhen, Guangdong (CN); Xiang ZHANG, Shenzhen, Guangdong (CN); Yi ZHENG, Shenzhen, Guangdong (CN); Yanqin WU, Shenzhen, Guangdong (CN); Chen GAO, Shenzhen, Guangdong (CN); Qingfei ZHOU, Shenzhen, Guangdong (CN)

(73) Assignee: CHINA GREAT WALL TECHNOLOGY GROUP CO., LTD., Shenzhen (CN)

(21) Appl. No.: 18/526,728

(22) Filed: Dec. 1, 2023

(30) Foreign Application Priority Data
Aug. 16, 2023 (CN) 202311039050.6

(51) Int. Cl. G06F 7/523; G06F 15/78

(52) U.S. Cl. CPC G06F 7/523; G06F 15/7821

(57) ABSTRACT

This application is applicable to the field of machine learning technologies and provides a system and a method for target detection. The system includes: a controller and a coprocessor which is in communication connection with the controller. The controller is configured to perform at least some arithmetic operations of a target detection model based on a target image to be detected and/or data sent by the coprocessor. The coprocessor is configured to perform at least some arithmetic operations of the target detection model based on the target image to be detected and/or data sent by the controller. According to the system for target detection, the controller and the coprocessor are utilized to perform some of the arithmetic operations in the target detection model respectively to solve a problem of slow execution speed of target detection task in deployment of the target detection model.

### CROSS-REFERENCE TO RELATED APPLICATIONS

This application claims priority to Chinese patent application No. 202311039050.6, filed on Aug. 16, 2023, the entire contents of which are incorporated herein by reference.

### FIELD

The present application pertains to the field of machine learning technologies, and more particularly, to a system for target detection, a method for target detection, a terminal device, and a non-transitory computer-readable storage medium.

### BACKGROUND

Target detection is one of the core problems in the field of computer vision, and a task of the target detection is to determine all targets of interest in one image and determine categories and positions of these targets. In recent years, significant improvements have been made on the target detection with rapid development of technology of machine learning, and target detection is more and more widely used in many fields such as automatic driving, intelligent transportation, industrial quality detection, target tracking and face detection. It can be understood that, in some fields, accuracy and instantaneity during an execution of a target detection task are particularly important.

In order to improve the accuracy of the target detection, a feasible method is to improve an accuracy of feature extraction of a target detection model by improving the complexity of the target detection model. However, the amount of parameters increases with the increase of the number of layers of the target detection model, time consumption on calculation will be significantly increased.

On the contrary, although a speed of reasoning can be increased by merely simplifying the model structure, a reduction of accuracy will be inevitably resulted.

Thus, there is an urgent need to provide a method that enables a balance between the accuracy and the instantaneity during execution of the target detection task.

### SUMMARY

Embodiments of the present application provide a system for target detection, method for target detection, a target detection apparatus, a device and a non-transitory computer-readable storage medium that can solve the problem on how to balance the accuracy and the instantaneity of the target detection.

In the first aspect, a system for target detection is provided in one embodiment of the present application, this system includes a controller and a coprocessor, the controller and the coprocessor are in communication connection;
the controller is configured to perform at least some arithmetic operations of a target detection model according to a target image to be detected and/or data sent by the coprocessor so as to obtain one or a plurality of first result(s), each of the first result(s) includes a data result to be transmitted to the coprocessor;
the coprocessor is configured to perform at least some arithmetic operations of the target detection model according to the target image to be detected and/or data sent from the controller so as to obtain one or a plurality of second result(s), each of the second result(s) comprises a data result to be transmitted to the controller;
the target detection model is a machine learning model obtained by training an initial model according to a sample, there exists at least one data result for obtaining a target detection result of the target image to be detected in the first result(s) and the second result(s).

In one possible implementation mode of the first aspect, the initial model includes a first sampling module configured to extract an image feature, and the first sampling module includes at least two convolution branches with different sizes. The target detection model includes a second sampling module, and the second sampling module is obtained by fusing the at least two convolution branches of the first sampling module.

In one possible implementation mode of the first aspect, the controller is further configured to transmit arithmetic instructions to the coprocessor; the coprocessor is configured to perform arithmetic operations on instructions parts of the target detection model according to the arithmetic instructions to obtain the second result(s). The arithmetic instructions are in one-to-one correspondence with the instruction parts of the target detection model.

In one possible implementation mode of the first aspect, the coprocessor includes an instruction memory configured to store the arithmetic instructions.

In one possible implementation mode of the first aspect, the second result further includes a data result used as an input parameter for performing at least some arithmetic operations of the target detection model.

In one possible implementation mode of the first aspect, the coprocessor includes a tensor memory, the tensor memory is configured to store:
a first result in a tensor form and being sent from the controller to the coprocessor; and/or,
a second result in the tensor form and being used for performing at least some arithmetic operations of the target detection model.

In one possible implementation mode of the first aspect, the coprocessor further includes a cooperative controller, and the cooperative controller may be configured to decode the arithmetic instructions in the instruction memory to obtain instruction decoding information.

In one possible implementation mode of the first aspect, the coprocessor further includes an arithmetic unit, the arithmetic unit is configured to invoke data in the tensor memory as input data, perform the arithmetic operations on the instruction parts of the target detection model according to the instruction decoding information to obtain the second result(s), and write the second result(s) into the tensor memory.

In one possible implementation mode of the first aspect, each convolution branch includes a first-type branch, and the first-type branch includes a convolutional layer and a normalization layer connected in sequence.

In one possible implementation mode of the first aspect, the coprocessor includes an arithmetic unit, and the arithmetic unit includes a convolution subunit configured to perform an arithmetic operation of the convolution layer in the first-type branch.

In one possible implementation mode of the first aspect, the convolution subunit is composed of a plurality of multiply-adder arrays having a preset number that matches with a size of a feature map of the target detection model.

In one possible implementation mode of the first aspect, the coprocessor includes an arithmetic unit, the arithmetic unit includes a post-processing subunit that may be configured to perform an arithmetic operation of the normalization layer in the first-type branch.

In one possible implementation mode of the first aspect, the convolution branch includes a second-type branch, the second-type branch is a direct connection branch configured to map a value of a direct connection branch input to an output of the direct connection branch.

In one possible implementation mode of the first aspect, the coprocessor includes an arithmetic unit, the arithmetic unit includes a direct connection subunit configured to perform a direct connection arithmetic operation in the second type of branch.

In one possible implementation mode of the first aspect, the direct connection subunit is composed of a shift register and a plurality of pipeline units; the plurality of pipeline units may store neighborhood pixels and obtain a convolution result through the shift register;
each of the pipeline units is composed of a plurality of multipliers having a first number and a plurality of adders having a second number, the first number is equal to a maximum value of a single-channel convolution kernel operand of any feature map in the target detection model, and the second number is equal to a value of subtracting a convolutional weight of the maximum convolution kernel in the target detection model by 1.

In one possible implementation mode of the first aspect, the first sampling module includes:
a first down-sampling structure composed of two first-type branches; and
a first feature extraction structure composed of two first-type branches and a second-type branch.

In one possible implementation mode of the first aspect, an output of the first down-sampling structure is connected to an activation function layer.

In one possible implementation mode of the first aspect, the coprocessor includes an arithmetic unit, the arithmetic unit includes a post-processing subunit that may be configured to perform an arithmetic operation of the activation function layer.

In one possible implementation mode of the first aspect, the initial network includes N dimension reduction layers connected in sequence. N is an integer greater than 2. The N dimension reduction layers include:
a first dimension reduction layer formed by one said first down-sampling structure;
a second dimension reduction layer formed by sequentially connecting one said first down-sampling structure and two said first feature extraction structures; and
a third dimension reduction layer formed by sequentially connecting one said first down-sampling structure and three said first feature extraction structures.

In one possible implementation mode of the first aspect, the initial network further includes N dimension raising layers connected in sequence. The N dimension raising layers includes:
a pooling dimension raising layer composed of a pooling layer, a CBL layer and an upper-sampling layer connected in sequence;
a fusion dimension rising layer composed of a feature fusion layer, a CBL fusion layer, a CBL layer and an upper-sampling layer connected in sequence;
an output layer composed of a CBL layer, a feature fusion layer, a CBL fusion layer and a convolutional layer connected in sequence; and
an output layer composed of the feature fusion layer, the CBL fusion layer and the convolutional layer connected in sequence.

The CBL fusion layer includes a first CBL branch, a second CBL branch, and a CBL fusion and output structure, an output of the first CBL branch and an output of the second CBL branch are connected to an input of the CBL fusion and output structure, each of the first CBL branch and the second CBL branch is composed of a plurality of CBL sub-layers, a number of CBL sub-layers of the first CBL branch and a number of CBL sub-layers of the second CBL branch are different. The CBL fusion and output structure includes a feature fusion sub-layer and a CBL sub-layer which are connected in sequence.

In one possible implementation mode of the first aspect, for any value of i in a first specified range, an output of a i-th dimension reduction layer is connected to a feature fusion layer in a j-th dimension raising layer, where, i+j=n+1.

In one possible implementation mode of the first aspect, for any value of k in a second specified range, an output of the CBL layer in a k-th dimension raising layer is connected to a feature fusion layer in a j-th dimension raising layer. Where, k+l=n+1.

In one possible implementation mode of the first aspect, the output layer is configured to output the target detection result with a specified size; and an output of a n-th dimension reduction layer is connected to an input of the pooling dimension raising layer, the fusion dimension raising layer is disposed below the pooling dimension raising layer, the output layer is disposed below the fusion dimension raising layer.

In one possible implementation mode of the first aspect, the coprocessor further includes a cooperative controller, and the cooperative controller may be configured to: perform a training operation on the initial model according to an instruction sent by the controller to obtain a training result, and transmit the training result to the controller.

In one possible implementation mode of the first aspect, the controller is further configured to:
update parameters of the initial model according to the training result to obtain a trained initial model; and
fuse operations of the convolutional layer and operations of the normalization layer of the first-type branch in the trained initial model to obtain a fused branch.

In one possible implementation mode of the first aspect, the controller is further configured to:
adjust convolution kernels of the fused branch in the first down-sampling structure of the trained initial model to the same size in a first preset manner; and/or
adjust the fused branch and the second-type branch in the first feature extraction structure of the trained initial model to convolution structures having a same convolution kernel size in a second preset manner.

In one possible implementation mode of the first aspect, the arithmetic unit includes a post-processing subunit, the post-processing subunit includes a standby arithmetic component, and the standby arithmetic component may be configured to perform a designated arithmetic task of non-convolution computation and non-activation-function computation.

In one possible implementation mode of the first aspect, the post-processing subunit is composed of following components, including:
a first component configured to convert an integer into a floating-point number;
a second component configured to convert the floating-point number into an integer;
a third component configured to perform a floating-point multiply-add arithmetic operation; and
a fourth component configured to perform an activation function layer arithmetic operation.

In one possible implementation mode of the first aspect, the tensor memory includes:
an input cache region having a storage space that matches with an input cache region of the target image to be detected;
a feature cache region having a storage space that matches with a feature cache region of a feature map tensor, the feature map tensor is at least some of output data of any dimension reduction layer or any dimension raising layer of the target detection model;
a weight cache region having a storage space that matches with a model weight parameter quantity of the target detection model; and
an output cache region having a storage space that matches with the target detection result of the specified size.

In one possible implementation mode of the first aspect, the cooperative controller is further configured to: store, according to calculation result form information in the instruction decoding information, the second result calculated by the arithmetic unit according to the instruction decoding information in the tensor memory in preset manners. The preset manners correspond to the calculation result form information in a one-to-one correspondence manner.

In one possible implementation mode of the first aspect, said storing, according to the calculation result form information in the instruction decoding information, the second result calculated by the arithmetic unit according to the instruction decoding information in the tensor memory in preset manners includes:
determining the calculation result form information in the instruction decoding information as a two-dimensional tensor, sequentially storing the second result in a two-dimensional tensor form calculated by the arithmetic unit according to the instruction decoding information in the tensor memory according to a sequence of channels, and data in any channel is stored in the tensor memory according to a row major or a column major.

In one possible implementation mode of the first aspect, said storing, according to the calculation result form information in the instruction decoding information, the second result calculated by the arithmetic unit according to the instruction decoding information in the tensor memory in preset manners, includes:
determining the calculation result form information in the instruction decoding information as a three-dimensional tensor, and storing the second result in a three-dimensional tensor form and calculated by the arithmetic unit according to the instruction decoding information in specified three-dimensional storage blocks of the tensor memory;
the three-dimensional storage blocks are a plurality of preset storage blocks in the tensor memory, a storage space of any one of the three-dimensional storage blocks matches a three-dimensional feature map size of the target detection model, and a storage address of each bit in the three-dimensional storage block corresponds to a channel serial number, a tile serial number, and an in-tile row and column number of a second result in a three-dimensional tensor form.

In one possible implementation mode of the first aspect, the system for target detection further includes an image sensor. The image sensor is configured to read the target image to be detected or the sample, and transmit the target image to be detected or the sample to the controller.

In a second aspect, method for target detection is provided in one embodiment of the present application, the method for target detection is applied to a controller and includes:
obtaining a target image to be detected;
generating an arithmetic instruction corresponding to a first specific structure of a target detection model, the arithmetic instruction is used for controlling the coprocessor to perform an operational task of the first specific structure;
obtaining a second result, the second result includes an arithmetic operation result of the first specific structure;
performing an arithmetic operation on a second specific structure of the target detection model according to the second result and/or the target image to be detected so as to obtain a first result; and
obtaining a target detection result of the target image to be detected according to the first result and/or the second result.

The target detection model is a machine learning model obtained by training an initial model according to a sample.

In one possible implementation mode of the second aspect, the first specific structure and the second specific structure are constituted as the target detection model.

In one possible implementation mode of the second aspect, after the step of obtaining the target image to be detected, the method further includes:
performing color normalization on the target image to be detected and sending the target image to be detected after the color normalization to the coprocessor.

In one possible implementation mode of the second aspect, each of the target detection model and the initial model includes a dimension reduction part, a dimension raising part and a post-processing part which are connected in sequence;
the dimension reduction part is used for performing a feature extraction on the target image to be detected to obtain a plurality of dimension-reduced features. The dimension raising part is used for performing a feature fusion on the dimension-reduced features to obtain at least one dimension-raised feature. The post-processing part is used for performing a full connection arithmetic operation on the dimension-raised features and outputting the target detection result.

The dimension reduction part of the initial model includes a first sampling module, the first sampling module includes at least two convolution branches with different sizes. The dimension reduction part of the target detection model includes a second sampling module which is obtained by fusing the at least two convolution branches of the first sampling module.

In one possible implementation mode of the second aspect, before the step of obtaining the second result, the method further includes:
generating an instruction for training, the instruction for training is used for controlling the coprocessor to perform a sample-based training operation;
obtaining a training result, and updating parameters of the initial model according to the training result so as to obtain a trained initial model, the training result is a result obtained by the coprocessor by training according to the instruction for training; and
fusing operations of the convolutional layer and operations of the normalization layer of the convolution branch in the trained initial model to obtain the initial model with a fused branch.

In one possible implementation mode of the second aspect, after the step of fusing the operations of the convolutional layer and the operations of the normalization layer of the convolution branch in the trained initial model to obtain the initial model with the fused branch, the method further includes:
performing steps to obtain the target detection model, the steps includes:
adjusting, in a first preset manner, a convolution kernel of the fused branch to the same size; and/or
adjusting, in a second preset manner, the fused branch and a direct connection branch to convolution structures having a same convolution kernel size.

In one possible implementation mode of the second aspect, after the step of obtaining the target detection model, the method further includes:
sending a model weight parameter of the target detection model to the coprocessor.

In one possible implementation mode of the second aspect, the second specific structure includes a full connection layer and/or a non-maximum value suppression layer in a post-processing part of the target detection model.

In a third aspect, method for target detection being applied to a coprocessor is provided, the method includes:
obtaining an arithmetic instruction generated by a controller and corresponding to a first specific structure of a target detection model;
performing arithmetic operations on the first specific structure of the target detection model according to the arithmetic instruction so as to obtain a second result. The second result is used as an input parameter utilized by the controller for performing at least some of the arithmetic operations of the second specific structure of the target detection model; and/or the second result is used as an input parameter for obtaining a target detection result of the target image to be detected.

The target detection model is a machine learning model obtained by training the initial model according to a sample.

In one possible implementation mode of the second aspect, the first specific structure and the second specific structure are constituted as the target detection model.

In one possible implementation mode of the second aspect, before the step of obtaining the arithmetic instruction generated by the controller and corresponding to the first specific structure of the target detection model, the method further includes:
obtaining an instruction for training, and performing a sample-based training operation according to the instruction for training so as to obtain a training result.

In one possible implementation mode of the second aspect, before the step of obtaining the arithmetic instruction generated by the controller and corresponding to the first specific structure of the target detection model, the method further includes:
obtaining a model weight parameter of the target detection model. The model weight parameter is used for performing an arithmetic operation on the first specific structure of the target detection model.

In one possible implementation mode of the second aspect, each of the target detection model and the initial model includes a dimension reduction part, a dimension raising part and a post-processing part which are connected in sequence.

The dimension reduction part is used for performing a feature extraction on the target image to be detected so as to obtain a plurality of dimension-reduced features. The dimension raising part is used for performing a feature fusion on the dimension-reduced features so as to obtain at least one dimension-raised feature. The post-processing part is used for performing a full connection arithmetic operation on the at least one dimension-raised feature and outputting the target detection result.

The dimension reduction part of the initial model includes a first sampling module, the first sampling module includes at least two convolution branches with different sizes. The dimension reduction part of the target detection model includes a second sampling module which is obtained by fusing the at least two convolution branches of the first sampling module.

In one possible implementation mode of the second aspect, the first specific structure includes:
a down-sampling layer, a feature extraction layer, a normalization layer, a direct connection branch, and an activation function layer in the dimension raising part of the target detection model; and
a pooling layer, a CBL layer, an upper-sampling layer, a feature fusion layer, and an activation function layer in a dimension reduction part of the target detection model.

In one possible implementation mode of the second aspect, the down-sampling layer includes a convolution layer, a normalization layer and an activation function layer. The feature extraction layer includes a convolution layer, a normalization layer and a direct connection branch.

The step of performing the operation on the first specific structure of the target detection model according to the arithmetic instruction so as to obtain the second result includes:
invoking, when determining that the arithmetic instruction is as an arithmetic operation of the convolutional layer, a convolution subunit to perform the arithmetic operation; or
invoking, when determining that the arithmetic instruction is an arithmetic operation of the direct connection branch, a direct connection subunit to perform the arithmetic operation; or
invoking, when determining that the arithmetic instruction is an arithmetic operation of the normalization layer or an arithmetic operation of the activation function layer, the post-processing subunit to perform the arithmetic operation.

In the fourth aspect, a terminal device is provided in one embodiment of the present application. The terminal device includes a memory, a processor, and a computer program stored in the memory and executable on the processor. The processor is configured to, when executing the computer program, the aforesaid method for target detection.

In the fifth aspect, a non-transitory computer-readable storage medium is provided in one embodiment of the present application. The non-transitory computer-readable storage medium stores a computer program, that, when executed by a processor of the terminal device, causes the processor of the terminal device to implement the aforesaid method for target detection.

In the sixth aspect, a computer program product is provided in one embodiment of the present application. When the computer program product is executed on the terminal device, the terminal device is caused to perform the aforesaid method for target detection.

Compared with the prior art, the beneficial effects of the embodiments of the present application are described below:

The controller and the coprocessor are utilized to perform some arithmetic operations in the target detection model respectively, in order to solve the problem of low execution speed of the target detection task in the deployment of the target detection model.

In particular, by decomposing the computational tasks in the target detection model and performing the arithmetic operations by the controller and the coprocessor respectively, the advantages of the controller and the coprocessor in hardware performance can be utilized comprehensively. Thus, the instantaneity and the accuracy of the target detection are balanced.

### DESCRIPTION OF THE DRAWINGS

In order to describe the technical solutions in the embodiments of the present application more clearly, a brief introduction regarding the accompanying drawings that need to be used for describing the embodiments of the present application or the existing technologies is given below. It is obvious that the accompanying drawings described below are merely some embodiments of the present application, a person of ordinary skill in the art can also acquire other drawings according to these drawings without paying creative efforts.

FIG. 1 illustrates a first schematic architecture diagram of a system for target detection provided by one embodiment of the present application;

FIG. 2 illustrates a schematic diagram of comparison between a first sampling module and a second sampling module provided by one embodiment of the present application;

FIG. 3 illustrates a schematic diagram of a first architecture of a coprocessor according to one embodiment of the present application;

FIG. 4 illustrates a schematic architecture diagram of a first down-sampling structure according to one embodiment of the present application;

FIG. 5 illustrates a schematic architecture diagram of a first feature extraction structure according to one embodiment of the present application;

FIG. 6 illustrates a schematic architecture diagram of a target detection network according to one embodiment of the present application;

FIG. 7 illustrates a schematic diagram of fusion operation according to one embodiment of the present application;

FIG. 8 illustrates a schematic architectural diagram of a pooling dimension raising layer and a fused dimension raising layer according to one embodiment of the present application;

FIG. 9 illustrates a second schematic architecture diagram of a coprocessor according to one embodiment of the present application;

FIG. 10 illustrates a second schematic architecture diagram of a system for target detection according to one embodiment of the present application;

FIG. 11 illustrates a schematic flow diagram of a method for target detection applied to a controller according to one embodiment of the present application;

FIG. 12 illustrates a schematic flow diagram of a method for target detection applied to a coprocessor according to one embodiment of the present application;

FIG. 13 illustrates a schematic structural diagram of a terminal device according to one embodiment of the present application.

Reference numerals are listed below:

controller 110; coprocessor 120; instruction memory 121; cooperative controller 122; arithmetic unit 123; tensor memory 124; input/output module 125; sensor 130; first sampling module 210; first down-sampling structure 211; first feature extraction structure 212; second sampling module 220; activation function layer 230; pooling dimension raising layer 810; second acquisition component 1330; first arithmetic component 1340; classification component 1350; third acquisition component 1410; second arithmetic component 1420; terminal device 150; processor 1501; memory 1502; computer program 1503.

### DETAILED DESCRIPTION OF EMBODIMENTS

In the following descriptions, in order to describe but not intended to limit the present application, concrete details including specific system structure and technique are proposed to facilitate a comprehensive understanding of the embodiments of the present application. However, a person of ordinarily skill in the art should understand that, the present application can also be implemented in some other embodiments without these concrete details. In other conditions, detailed explanations of method, circuit, device and system well known to the public are omitted, so that unnecessary details which are disadvantageous to understanding of the description of the present application may be avoided.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

It should also be understood that, terms “and/or” used in the description and the annexed claims of the present application are referred to as any combination of one or a plurality of listed item(s) associated with each other and all possible items, and including these combinations.

As is used in the description and the annexed claims, a term “if” may be interpreted as “when” or “once” or “in response to determination” or “in response to detection”. Similarly, terms such as “if it is determined that”, or “if it is detected that (a described condition or event)” may be interpreted as “once it is determined” or “in response to the determination” or “once it is detected that (the described condition or event)” or “in response to the detection (the described condition or event)”.

In addition, in the descriptions of the present application, terms such as “first” and “second”, “third”, etc., are only used for distinguishing purpose in description, but shouldn't be interpreted as indication or implication of a relative importance.

The descriptions of “referring to one embodiment” or “referring to some embodiments”, or the like as described in the specification of the present application means that a specific feature, structure, or characters which are described with reference to this embodiment are included in one embodiment or some embodiments of the present application. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless otherwise they are specially emphasize in other manner. The terms of “comprising”, “including”, “having” and their variations have the meaning of “including but is not limited to”, unless otherwise they are specially emphasized in other manner.

Target detection is an important task in the field of computer vision, which seeks to recognize and locate a particular target in an image or a video. The target detection plays a key role in many applications, such as automatic driving, object recognition, video monitoring, and face detection. In the past decades, the field of target detection has been significant developed, and has be gradually transited from a conventional method implemented by manually designing features to a method based on neural network.

That is, the utilization of a machine learning model, especially a deep learning model based on a neural network, is an effective method for target detection.

For a target detection network, the larger the number of layers is, the huger the amount of parameters is, and the higher the accuracy is. However, as for a chip, since a deployment environment of the chip is an edge end and the requirement of computing performance of the chip is not high, if a network having super-large amount of parameters is deployed, the requirement of instantaneity cannot be met during actual reasoning. Thus, how to balance the computing power and the accuracy for a neural network structure with huge amount of parameters and a gradually increased edge scene AI calculation task requirement has become a problem that needs to be solved urgently.

One possible solution is to solve the above-mentioned problem by using a lightweight network, which takes the problem of execution efficiency into account essentially.

The execution efficiency refers to unification of the arithmetic speed of the model and prediction precision of the model, and a standard for evaluating an execution efficiency of an algorithm is divided into a space complexity, a time complexity and an accessed memory size of an algorithm model.

When the chip is deployed at various edge ends such as intelligent security, automatic driving, smart home, and wearable smart device, although the deployment scenarios are different, a target detection task is the most common operation, how to better use a deep neural network model has become the most hot issue currently.

For chips deployed in various edge environments, the performance of the target detection network determines the execution efficiency of the target detection. However, the problem of adaptability between the hardware structure (such as a chip) and the network is often ignored by the existing solution.

Thus, establishing the target detection network (relatively lightweight) inside the chip, and adding a neural coprocessor 120 by an external hardware system to specially process network parameters so as to make up for the problem of reduction of accuracy after lightweight may be considered, the execution efficiency of the network can be greatly improved.

Aiming at software and hardware collaborative design for AI chip target detection, some embodiments of the present application provide a relatively lightweight target detection network (i.e., the target detection model). Although the lightweight network can reduce a recognition accuracy of the entire network, the real-time capability can be greatly improved. Then, in order to make up for the problem of the reduction of the recognition accuracy of the lightweight network, a hardware structure is provided, the neural coprocessor 120 is added to improve the recognition accuracy of the target detection network.

It is worth noting that the “lightweight” of the target detection model is “lightweight” relative to a chip that executes operation for a model, that is, the target detection model deployed on an edge scene is more “lightweight” relative to the target detection model deployed at a server end (i.e., the scale of the model weight parameter is smaller). As for a certain specific application scenario, the scale of the model weight parameter of the deployed target detection model should match with the hardware computing performance in the scene.

On this basis, an arithmetic speed and the accuracy/a recall rate of the target detection model can be more positively affected by introducing specific hardware.

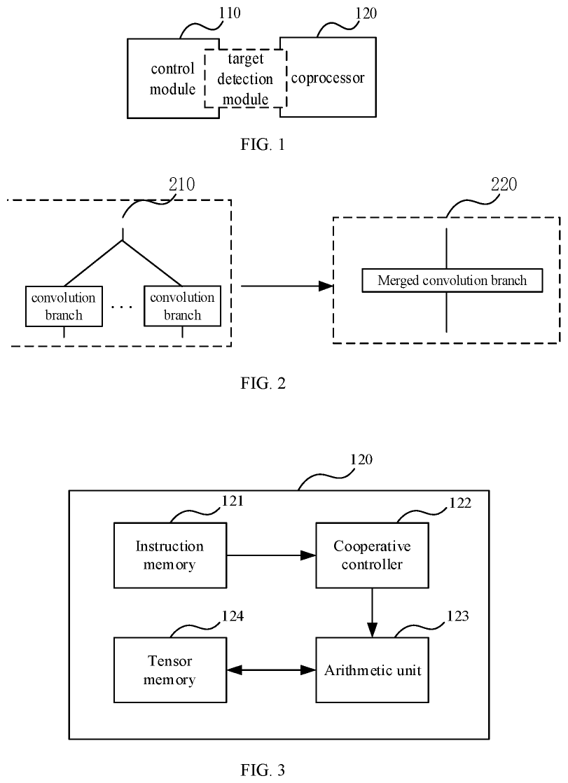

In particular, as shown in FIG. 1, a system for target detection is provided in one embodiment of the present application, the system for target detection includes a controller 110 and a coprocessor 120, the controller 110 is in communication connection with the coprocessor 120.

The controller 110 is configured to perform at least some arithmetic operations of the target detection model according to the target image to be detected and/or the data sent by the coprocessor 120 so as to obtain one or a plurality of first results. The first result includes a data result used to be sent to the coprocessor 120.

The coprocessor 120 is configured to perform at least some arithmetic operations of the target detection model according to the target image to be detected and/or data sent by the controller 110 so as to obtain one or a plurality of second results. The second result includes a data result used to be sent to the controller 110.

The target detection model is a machine learning model obtained by training an initial model according to a sample. There exists at least one data result for obtaining the target detection result of the target image to be detected in the first result and the second result.

In this embodiment, the controller 110 can obtain the target image to be detected, and the target image to be detected is input data for target detection. For the system for target detection provided in this embodiment, arithmetic tasks of the target detection model (in some optional embodiments the target detection model is a neural network model, in these embodiments, the target detection model is also referred to as a target detection network) are implemented on the controller 110 and the coprocessor 120, respectively. Thus, with reference to the example of FIG. 1, it can be understood that the target detection model is partially deployed on the controller 110 and partially deployed on the coprocessor 120.

In the actual application process of the system provided in this embodiment, the target detection model is not explicitly deployed in one certain physical space like other physical hardware, instead, the target detection model is stored in the memory of the controller 110 and/or the coprocessor 120 in the form of model weight parameters. In particular, the storage mode of the model weight parameters may be the first deployment mode in which all model weight parameters are stored on the controller 110 and the coprocessor 120, or be the second deployment mode in which the controller 110 stores the first part of the model weight parameters and the coprocessor 120 stores the second part of the model weight parameters.

It should be noted that, more arithmetic units, excepting the controller 110 and the coprocessor 120, are not explicitly limited in this embodiment. That is, in some optional implementations, more arithmetic units may also be included to complete all arithmetic operations of the target detection model in cooperation manner.

As for the first deployment mode, when the controller 110 and the coprocessor 120 (other arithmetic units are similar to the controller 110 and the coprocessor 120) to perform respective arithmetic tasks, the controller 110 and the coprocessor 120 invoke the corresponding model weight parameters to complete at least some arithmetic operations of the target detection model. In this condition, it may also be understood that the target detection model is deployed on the controller 110 and the coprocessor 120 respectively (which is slightly different from the example provided in FIG. 1, in this condition, a complete target detection model is deployed on the controller 110 and the coprocessor 120, however, only some model weighting parameters are involved during execution of the arithmetic operations).

The second deployment mode is one preferable embodiment of this embodiment, the respectively deployed model weight parameters are strictly corresponding to the arithmetic tasks needed to be performed by the controller 110 and the coprocessor 120. On this basis, the controller 110 and the coprocessor 120 have faster invoking speed of model weight parameters.

Furthermore, on the basis of the second deployment mode, the specific task of the target detection model can be decomposed, and the model weight parameters of the same category of arithmetic operation are stored in a specific address, so that the controller 110 and the coprocessor 120 can directly read the model weight parameters from the specific address when executing the specific arithmetic task.

Furthermore, which task that the controller 110 and the coprocessor 120 In particular process depends on the architecture of the target detection model, the hardware configuration of the controller 110, and the hardware configuration of the coprocessor 120. That is, the arithmetic task of the target detection model executed by the controller 110 matches with the hardware configuration of the controller 110, and the arithmetic task of the target detection model executed by the coprocessor 120 matches with the hardware configuration of the coprocessor 120 (other arithmetic units are similar to the controller 110 and the coprocessor 120).

For example, for the target detection network, more convolution computations need to be performed, thus, the coprocessor 120 may be configured as a graphics processing unit (GPU) having a strong floating-point number capability. For another example, the coprocessor 120 may be configured as a tensor processing unit (TPU) 123 for a target detection network with a relatively higher channel number/feature map dimension. For another example, the coprocessor 120 may be configured as an application-specific integrated circuit (ASIC) for a specific target detection model.

In one optional embodiment, more arithmetic units such as the GPU, the TPU, the ASIC, and a field-programmable gate array (FPGA) may also be used. The arithmetic units are limited to the configurations of the controller 110 and the coprocessor 120, the arithmetic operations of the target detection model are implemented through cooperation of more arithmetic units.

By way of example rather than limitation, the controller 110 may be a micro controller 110 (MCU), and the coprocessor 120 may be a neural coprocessor 120 (CoprocessorNCP).

In an example based on the MCU, the NCP, and the target detection network, a task distribution of the coprocessor 120 and the controller 110 may be configured as: during an reasoning process, the NCP executes a dense CNN primary workload, and the MCU only performs light load preprocessing (e.g., color normalization) and post-processing (e.g., full connection layer, non-maximum suppression, etc.).

Exemplarily, after performing a preprocessing arithmetic operation (such as color normalization, noise elimination, etc.) on the target image to be detected by the controller 110 (i.e., the MCU), the controller 110 obtains a first result, and sends the first result to the coprocessor 120 (i.e., the NCP). The coprocessor performs network computing (e.g., feature extraction, down-sampling, normalization, etc.) and obtains one or a plurality of second result(s), and sends the second result(s) to the MCU. The MCU may perform subsequent arithmetic operations according to the second result(s) to obtain a second first result and further obtain the target detection result, or obtain the target detection result through the one or plurality of second result(s).

In this example, as for the coprocessor 120, the data sent by the controller 110 may be a first result or be a control instruction. Thus, it can be understood that, in the above example, the controller 110 (e.g., the MCU) is used as a main control unit, and the coprocessor 120 (e.g., the NCP) is used as a main arithmetic unit (i.e., the unit that is mainly used for arithmetic operation) to realize the target detection.

In some other alternative embodiments, duties of the main control and the main computing of the controller 110 and the coprocessor120 may be switched.

In this embodiment, the initial model may apply a target detection model such as Faster R-CNN, or SSD or YOLO v3, a previously acquired sample is used to train the target detection model so as to obtain a trained model. The controller and the coprocessor 120 perform some arithmetic operations on the target detection model respectively, such that a problem that the execution efficiency of the target detection task is relatively low due to insufficient computing performance of the edge end when the target network model is deployed at the edge end can be compensated in some scenarios.

Optionally, the controller 110 may pre-process the target image to be detected after obtaining the target image to be detected, for example, operations such as color normalization and image scaling. Through color normalization, the influence of ambiguity of target contour due to the illumination or the shadow of the target image to be detected in acquisition process, and the little difference between the target contour and the surrounding environment are eliminated, and the obtained target image to be detected can be converted into a picture format and a size suitable for computing of the target detection model through image scaling.

As one preferable embodiment, the controller 110 performs light load processing in the target detection unit, for example, the controller 110 classifies the acquired feature map to obtain a target detection result. The light load processing is performed by the controller 110, and the coprocessor 120 processes a large amount of data to improve the arithmetic speed.

Furthermore, in the example of the MCU and the NCP, the controller 110 and the coprocessor 120 may be connected through an SDIO/SPI interface, perform image and data transmission through the SDIO/SPI interface, and perform real-time data transmission by utilizing a high-bandwidth function of the SDIO/SPI interface. A typical SDIO may provide bandwidth up to 500 Mbps, exemplarily, about 300 frame per second (FPS) may be transmitted for 256×256×3 images, and 1200 frame per second (FPS) may be transmitted for 128×128×3 images. For a relatively slow SPI, 100 Mbps can still be reached, or an equivalent throughput of 256×256×3 images is 60 fps.

The beneficial effects of this embodiment lie in:

The controller 110 and the coprocessor 120 are utilized to perform some arithmetic operations in the target detection model respectively, so as to solve the problem of slow execution speed of the target detection task in the deployment of the target detection model.

In particular, by decomposing the arithmetic tasks in the target detection model and respectively distributing the arithmetic tasks to the controller 110 and the coprocessor 120, such that the advantages of the controller 110 and the coprocessor 120 in hardware performance can be integrated, and a real-time performance and an accuracy of target detection can be balanced.

According to the above embodiment, in yet another embodiment:

The initial model includes a first sampling module 210, the first sampling module 210 is configured to extract an image feature, and the first sampling module 210 includes at least two convolution branches with different sizes. The target detection model includes a second sampling module 220, and the second sampling module 220 is obtained by fusing the convolution branches of the first sampling module 210.

In this embodiment of the present application, a target detection model for decoupling training and reasoning is provided, the model structure of the target detection model is a multi-branch structure in the training process. When the training is completed and a reasoning stage is entered, the overall model structure can be equivalently converted into a single-branch structure through methods such as structural reparameterization and other methods, in order to perform deployment and reasoning.

FIG. 2 illustrates a schematic diagram of fusion of branches, and the first sampling module 210 on the left side of FIG. 2 may be interpreted as a sampling unit having a plurality of branches in the initial model (it is worth noting that a non-sampling unit of the initial model may also have a plurality of branches). The second sampling module 220 on the right side of FIG. 2 may be interpreted as a sampling unit having fused convolution branches formed by fusing the convolution branches after the initial model is trained. The sampling unit with the fused convolution branches is constituted as at least a part of the target detection model.

In the above embodiment, in some edge scenarios, due to the factors such as cost, space and the like, a hardware system with higher computing resources may not be deployed, execution of a heavy model (i.e., the target detection model having large computation and a large number of parameters) on hardware is affected (the heavy model will spend more time on these hardware in order for computing and reasoning, thereby resulting in an unacceptable acquisition time of the target detection result).

However, if a lightweight model is simply deployed (equivalent to a target detection model with less computations and less parameters), the accuracy of the model is inevitably sacrificed (in order to arrive at a faster calculation speed). Thus, in this embodiment, some improvements have been made in order to solve this problem, by decoupling the training process and reasoning process of the target detection model, a better training effect is achieved through more branches of the training part which has low requirement on real-time capability. After the training is completed, these branches are fused to obtain a reasoning model with fewer branches. A vivid but not accurate metaphor is used to illustrate the fusion process, which is equivalent to simplifying a calculation process of multiple branches, thereby effectively reducing the amount of computation in the model reasoning process while obtaining an equivalent result (indeed, there exists a possibility of a slight decrease in the accuracy of the calculation result after fusing of multi branches, which depends on a specific solution of fusion of branches).

The beneficial effects of this decoupling training method lie in that:

The capability of the model can be enhanced in maximum in the training process. Moreover, due to the fact that the branches are fused in the reasoning process, the total amount of computation is compressed, so that the time required for reasoning can be reduced on the premise of ensuring the accuracy of reasoning and the recall rate.

According to any one of the aforesaid embodiments, a series of embodiments in which the controller 110 is provided as a master control unit and the coprocessor 120 is used as a master arithmetic unit, are provided below.

A system for target detection is provided in one embodiment of the present application. The controller 110 is further configured to send arithmetic instructions to the coprocessor 120. The coprocessor 120 is configured to perform arithmetic operation of the instruction portions of the target detection model according to the arithmetic instructions to obtain the second result. The arithmetic instructions correspond to the instruction portions in a one-to-one correspondence manner.

Correspondingly, in one selectable implementation mode of this embodiment, the coprocessor 120 includes an instruction memory 121 configured to store the arithmetic instructions.

In this embodiment, when the target detection task is performed, the controller 110 may generate and send the arithmetic instructions, the coprocessor 120 performs arithmetic operations in the target detection model according to the arithmetic instructions so as to obtain the second result. The arithmetic instructions include instructions required when the coprocessor 120 executes the target detection model.

In one optional implementation mode, the connection of arithmetic tasks does not need to be considered by the coprocessor 120. Instead, the connection of the arithmetic tasks is controlled by the controller 110, and the coprocessor 120 only needs to quickly perform a specific arithmetic task according to the arithmetic instruction, thereby improving the reasoning speed of the model to a certain extent.

The instruction memory 121 is used to store the arithmetic instructions. For one single target detection task, the coprocessor 120 may directly invoke the instructions in the instruction memory 121 to perform an arithmetic operation when the arithmetic operation is performed. In one optional implementation mode, an arithmetic instruction has execution sequence information, that is, the controller 110 does not need to generate the arithmetic instruction in real time, but can generate a plurality of arithmetic instructions having an execution sequence at an appropriate time, so that the coprocessor 120 invokes the arithmetic instructions and performs the arithmetic operation.

For example, the first arithmetic instruction is used to control the coprocessor 120 to perform a down-sampling operation, the second arithmetic instruction is used to control the coprocessor 120 to perform a feature extraction operation, the third arithmetic instruction is used to control the coprocessor 120 to perform a further down-sampling operation, and the fourth arithmetic instruction is used to control the coprocessor 120 to perform a further feature extraction operation.

Thus, the cooperative controller 122 can perform four arithmetic tasks in parallel or in series sequentially according to the first arithmetic instruction, the second arithmetic instruction, the third arithmetic instruction and the fourth arithmetic instruction to obtain four second results.

FIG. 3 illustrates an optional hardware structure of a coprocessor 120, the hardware structure. In particular includes an instruction memory 121, a tensor memory 124, a cooperative controller 122, and an arithmetic unit 123. The instruction memory 121 interacts with the controller 110 and is configured to store arithmetic instructions. The cooperative controller 122 can read and decode the arithmetic instructions in the instruction memory 121, and control the arithmetic unit 123 to perform a specified arithmetic operation according to an analysis result (instruction decoding information). The operation unit 123 can read the required input data from the tensor memory 124 before performing the arithmetic operation. After performing the arithmetic operation, the operation unit 123 can also store the result of arithmetic operation in the tensor memory 124.

Beneficial effects of the instruction controlled target detection method lie in:

In one aspect, the controller 110 can send a specified number of arithmetic instructions at a specified time, thereby reducing the number of times the data is transmitted between the controller 110 and the coprocessor 120, in another aspect, the cooperative controller 122 reads the arithmetic instructions sequentially through the independent instruction memory 121, and thus reducing an addressing time when instructions are read.

According to any one of the aforesaid embodiments, a structure embodiment regarding the initial model branch and the target detection model fused convolution branch are provided, and the specific arithmetic operation process of the coprocessor 120 and the controller 110 is described.

One embodiments of the present application provide a system for target detection, the second result further includes a data result used as an input parameter for performing at least some arithmetic operations of the target detection model.

For example, the second result may be a calculation result obtained by performing the convolution branch, and the coprocessor 120 may continue to perform some of the arithmetic operations of the target detection model according to the second result, or send the second result to the controller 110 which performs some arithmetic operations in the target detection model according to the second result.

For the implementation mode in which the controller 110 is taken as the main control unit, the computing tasks (for example, a convolution computation) with a relatively high requirement on computation power can be completed by the coprocessor 120. In the target detection model, one second result may be a basis of arithmetic operation of another second result. For example, a convolution computation result (possibly extracted feature map) may be an input parameter of another convolution computation, and some second results can be used as input parameters for performing at least some of the arithmetic operations of the target detection model. For the arithmetic task at the end of the target detection model, the second result of the coprocessor 120 (which may also be the controller 110 in some conditions) may correspond to the target detection result, this second result (or the first result) is used for obtaining the data result of the target detection result of the target image to be detected.

It should be noted that there may be multiple acquisition methods of the target detection result, and one optional method is to obtain a plurality of detection targets through the plurality of first results and/or the second result, and then perform non-maximum suppression on the plurality of detection targets so as to obtain an optimal detection target which is taken as the target detection result. Another optional method is to obtain detection targets of different sizes through the plurality of first results and/or second results, and output the detection targets as target detection results. In some alternative embodiments, the two methods can be combined.

By way of example rather than limitation, as for the solution of outputting the plurality of target detection results, confidence levels of the target detection results can also be output at the same time.

It can be understood that, the solution for performing complex convolution computations based on the coprocessor 120 is provided in some embodiments. In this solution, the efficiency of arithmetic operation of the coprocessor 120 can be further improved through the following method, that is:
the coprocessor 120 includes a tensor memory 124, and the tensor memory 124 is configured to store:
a first result in a tensor form, which is sent from the controller 110 to the coprocessor 120; and/or,
a second result in a tensor for, which is used for performing at least some arithmetic operations of the target detection model.

Similar to the above implementation method of the instruction memory 121, the independent tensor memory 124 can enable the coprocessor 120 to perform a specific arithmetic task without performing relatively complex data addressing and reading tasks, thereby improving the efficiency of arithmetic operation of the model to a certain extent.

In one optional implementation method, the tensor memory 124 may be one single-port static random-access memory (SRAM), the first result and the second result are stored by utilizing the characteristics of the SRAM that the SRAM has a rapid reading and storing speed and the original stored information is not damaged during reading, reading and writing speed is improved, and it is ensured that the stored first result or other data is not covered when the data result used for performing at least some arithmetic operations of the target detection model in the second result is stored. Thus, the coprocessor 120 can store and read the required result at any time during data processing process.

Furthermore, on the basis of the embodiments, due to the fact that the functions of the instruction memory 121, the tensor memory 124 (or other sub-units of the coprocessor 120 mentioned or not mentioned in the subsequent embodiment) are specialized, the operation function may be implemented by adding the simple processing unit on the coprocessor 120 without increasing hardware costs excessively, that is:

The coprocessor 120 further includes the cooperative controller 122, and the cooperative controller 122 can be configured to decode the arithmetic instructions in the instruction memory 121 so as to obtain instruction decoding information.

Furthermore, a specialized arithmetic unit 123 may be independently arranged on the coprocessor 120, that is:

The coprocessor 120 further includes an arithmetic unit 123, the arithmetic unit 123 is configured to invoke data in the tensor memory 124 as input data, perform arithmetic operations of the instruction portion of the target detection model according to the instruction decoding information to obtain the second result, and write the second result into the tensor memory 124.

Thus, the units of the arithmetic unit 123, the instruction memory 121 and the tensor memory 124 only need to implement the functions of arithmetic operations, read and write instructions, read and write tensor, the arrangement of hardware can be as simple and efficient as possible. Moreover, the cooperative controller 122 only needs to implement the functions of instruction decoding and control computation, and the requirement on hardware is also simple and efficient.

As a whole, the arithmetic unit 123 is mainly used for the arithmetic operations of the instruction part of the target detection model, when the arithmetic operations is performed, the arithmetic operations that need to be performed and the data that need to be processed are determined according to the instruction decoding information, the corresponding data is read from the tensor memory 124, arithmetic operation is performed on the corresponding data to obtain a calculation result, and the calculation result is written into the tensor memory 124. The result of writing may be used as an input of a next calculation for continuous calculation. As for the solutions of the MCU and the NCP, data may also be sent to the controller 110 through the SDIO/SPI interface, and the controller 110 continues to perform some other arithmetic operations of the target detection model.

When the coprocessor 120 is in operation, the cooperative controller 122 obtains the arithmetic instruction from the instruction memory 121, and decodes the arithmetic instruction to obtain a decoding information instruction. The decoding information instruction includes a reading instruction, an arithmetic instruction, and a write-back instruction. (For the solutions of the MCU and the NCP, after the controller 110 generates the arithmetic instruction, the arithmetic instruction is sent to the instruction memory 121 through the SDIO SPI interface).

The arithmetic unit 123 obtains required data from the tensor memory 124 according to the reading instruction. The required data includes a first result and a model weight of the target detection model. The obtained data is used as an input for performing the arithmetic instruction to obtain the second result, and the second result is written back to the corresponding position in the tensor memory 124 according to the write-back instruction.

The beneficial effects of the embodiments lie in:

The arithmetic tasks, and the control and execution task of the target detection model are completed by the cooperative controller 122 and the controller 110, respectively, reading and writing of the arithmetic instructions in the coprocessor 120 (sent by the controller 110), decoding of the instruction, reading and writing of the arithmetic data and the arithmetic function are decoupled, and separately executed, thereby improving the overall efficiency of arithmetic operation of the target detection model.

According to any one of the aforesaid embodiments, one embodiment of cooperation between the arithmetic operation of model and the hardware structure is provided from the perspective of the specific structure of the target detection model. In this embodiment:

The convolution branch includes a first-type branch, and the first-type branch includes a convolution layer and a normalization layer connected in sequence (or the first-type branch may be a batch normalization layer/BN layer).

The coprocessor 120 includes an arithmetic unit 123, and the arithmetic unit 123 includes a convolution subunit configured to perform an arithmetic operation of convolution layer in the first-type branch.

In one embodiment based on the MCU and the NCP, the convolution subunit may be composed of a preset number of multiplier arrays, and the preset number is matched with the size of the feature map of the target detection model. Through the number of multipliers matched with the size of the feature map used by the target detection model, the convolution sub-module is sufficient and non-redundant in hardware resources when performing arithmetic operation on the obtained data or the obtained tensor.

Furthermore, in one optional implementation mode, the coprocessor 120 includes an arithmetic unit 123, the arithmetic unit 123 includes a post-processing subunit, and the post-processing subunit may be configured to perform an arithmetic operation on a normalization layer in the first-type branch.

The convolution computation and the normalization computation in the convolution branch are respectively processed, such that the post-processing unit and the convolution sub-module can perform arithmetic operations in the plurality of convolution branches in parallel. When the post-processing subunit processes the normalization computation of the first convolution branch, the convolution sub-unit can perform the convolution computation corresponding to the second convolution branch to realize multi-thread parallel processing and improve data processing efficiency.

In addition to the first-type branch, in some optional embodiments, the convolution branch further includes a second-type branch, the second-type branch is a direct-connection branch, and the direct-connection branch is configured to map a value of an input of the direct-connection branch to an output of the direct-connection branch.

Correspondingly, the coprocessor 120 includes an arithmetic unit 123, and the arithmetic unit 123 includes a direct connection (DC) subunit configured to perform a direct connection arithmetic operation in the second type of branch.

Starting from the perspective of the hardware architecture, the direct connection subunit may be configured as a structure in the form of a pipeline to process a direct connection arithmetic operation in parallel. Similarly, similar solutions may also be applied to descriptions of other components in the arithmetic unit 123. In an implementation mode of a direct connection subunit of the pipeline architecture:

The direct connection subunit is composed of a shift register and a pipeline unit. The plurality of pipeline units can cache neighborhood pixels and obtain a convolution result through the shift register.

The pipeline unit is composed of a plurality of multipliers having a first number and a plurality of adders having a second number. The first number is equal to the maximum value of a single-channel convolution kernel operand of any feature map in the target detection model, and the second number is equal to a value of subtracting the convolution weight of the maximum convolution kernel in the target detection model by 1.

Based on the first-type branch and the second-type branch, in one preferable embodiment, the first sampling module 210 includes:
a first down-sampling structure 211 composed of two first-type branches; and
a first feature extraction structure 212 composed of two first-type branches and one second-type branch.

The multi-branch structure in this embodiment can enhance the capability of feature extraction of the model, although the amount of computation involved in the multi-branch structure is greater, the extra workload is reflected in the training process, as discussed in the aforesaid embodiments, the multiple branch structures can be combined in a structural reparameterization mode during model reasoning in the training process, thereby reducing the amount of computation, and speed up model reasoning without losing the feature extraction capability (in some solutions, the feature extraction capability is less reduced).

Optionally, the multiplier used in the convolution subunit is 8 bits. First, an input feature map (IF) and a core (KL) are converted into a matrix through arithmetic operation, then, an 8-bit MAC array is used to perform a matrix multiply-accumulate operation to realize convolution. By way of example rather than limitation, if the size of one feature map output by one of the target detection models is 40×40, the array of the multiplier may be 20×20 or 10×10.

In particular, when the direct connection unit is provided, the shift register, the multiplier and the adder may be constructed as a tree structure. The tree structure includes a plurality of pipeline units, each pipeline unit includes 9 multipliers and 8 adders, 9 is the maximum value of one single-channel convolution kernel operand of any feature map in the target detection model, 8 is a value of subtracting the convolution weight number of the maximum convolution kernel in the target detection model by 1.

In the aforesaid method, the arithmetic unit 123 of the coprocessor 120 performs the convolution computation in the target detection network and the convolution activation direct connection arithmetic operation in the target detection network, the arithmetic operations with greater amount of data is performed by the neural coprocessor 120. Thus, the load of the controller 110 in the target detection task is reduced.

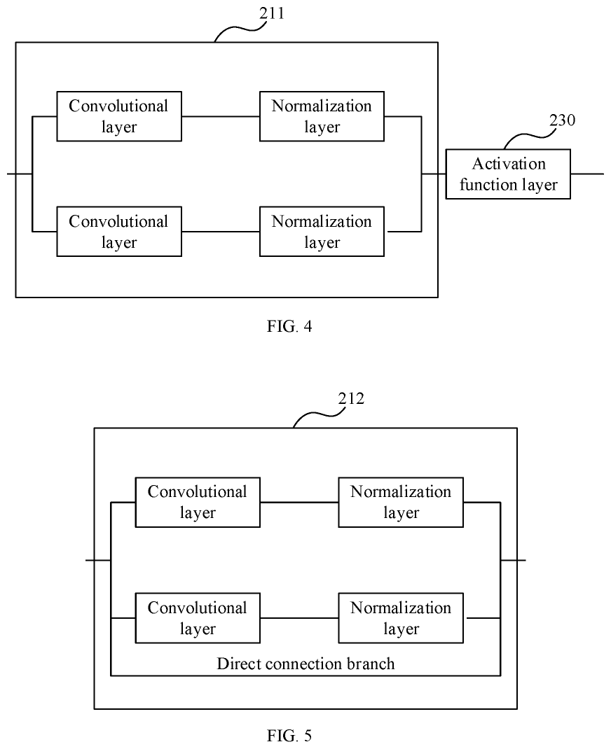

Referring to FIG. 4, the first down-sampling structure 211 is provided with two first-type convolution branches, a post-processing operation is added after convolution computation is performed on the feature map or the target image data to be detected, down-sampling is performed on the image or the feature map, so that the amount of the data to be processed in the target detection process is reduced. The convolution kernel sizes of two convolution branches of the down-sampling module are different. For example, the first convolution branch is a 3×3 convolution kernel, and the second convolution branch is a 1×1 convolution kernel.

The first feature extraction structure 212 is mainly configured to perform feature extraction on an image, and includes two first-type branches and one second-type branch, referring to FIG. 5 of the description. The two first-type convolution branches may have convolution kernels of different sizes, respectively. The feature extraction capability of the target detection model (initial network) is increased through the multi-branch structure.

Optionally, as shown in FIG. 4, an output of the first down-sampling structure 211 is connected to an activation function layer 230, the activation function layer 230 is used to perform a combined activation function arithmetic operation on the arithmetic operation results of the two first-type convolution branches of the first down-sampling structure 211.

Correspondingly, the coprocessor 120 includes an arithmetic unit 123, the arithmetic unit 123 includes a post-processing subunit, and the post-processing subunit may be configured to perform an arithmetic operation of the activation function layer 230.

Arranging the activation function layer 230 after the first sampling module is an important difference of this embodiment with respect to the prior art on the target detection model structure (as an alternative, on the target detection algorithm/software level), this arrangement facilitates improving the efficiency of feature extraction.

The beneficial effects of this embodiment lie in:

The multi-branch structure can enhance the feature extraction capability of the model, although the amount of computation involved in the multi-branch structure is greater, the multiple branch structure can be combined in the structural reparameterization mode during model reasoning in the training process. Thus, the amount of computation is reduced and model reasoning is speeded up, on the premise that the feature extraction capability (in some solutions, the feature extraction capability is less lost) is maintained.

Furthermore, in cooperation with the arithmetic operations of the multi-branch structure and other target detection models, hardware for convolution layer arithmetic operation, the irect connection branch arithmetic operation and the normalization layer arithmetic operation are arranged in the arithmetic unit 123. Thus, appropriate logic hardware is arranged for specific types of arithmetic tasks, and better model training and reasoning speed is obtained.

According to any one of the aforesaid embodiments, one embodiment of the specific architecture of the target detection model is provided below, in this embodiment:

The initial network includes N dimension reduction layers connected in sequence. N is an integer greater than 2. The N dimension reduction layers include:
a dimension reduction layer composed of one single first down-sampling structure 211;
a dimension reduction layer formed by sequentially connecting one said first down-sampling structure 211 and two said first feature extraction structures 212; and
a dimension reduction layer formed by sequentially connecting one said first down-sampling structure 211 and three said first feature extraction structures 212.

The initial network further includes N dimension raising layers connected in sequence, the N dimension raising layers include:
a pooling dimension raising layer 810 composed of a pooling layer, a CBL layer and an upper-sampling layer which are connected in sequence;
a fusion dimension raising layer 820 composed of a feature fusion layer, a CBL fusion layer, a CBL layer and an upper-sampling layer which are connected in sequence;
an output layer composed of a CBL layer, a feature fusion layer, a CBL fusion layer and a convolutional layer connected in sequence; and,
an output layer composed of a feature fusion layer, a CBL fusion layer and a convolution layer connected in sequence.

The CBL fusion layer includes a first CBL branch, a second CBL branch, and a CBL fusion output structure, and an output of the first CBL branch and an output of the second CBL branch are connected to an input of the CBL fusion output structure; the first CBL branch and the second CBL branch are each composed of a plurality of CBL sub-layers, the number of CBL sub-layers of the first CBL branch and the number of the CBL sub-layers of the second CBL branch are different, the CBL fusion output structure includes a feature fusion sub-layer and a CBL sub-layer which are connected in sequence.

The function of the CBL layer is to perform convolution (CONV), normalization (or batch normalization, BN) on input data, and activate (e.g., LeakyReLU).

Furthermore:

For any i value in the first specified range, an output of the i-th dimension reduction layer is connected to the feature fusion layer in the j-th dimension raising layer, where, i+j=n1.

For any k value in the second specified range, an output of the CBL layer in the k-th dimension raising layer is connected to the feature fusion layer in the 1-th dimension raising layer, where, k+l=n+1.

The output layer is configured to output the target detection result of a specified size; and an output of the n-th dimension reduction layer is connected to an input of the pooling dimension raising layer 810, after the fusion dimension raising layer 820 is disposed below the pooling dimension raising layer 810, the output layers (both of the two output layers) are disposed below the fusion dimension raising layer 820.

FIG. 8 illustrates an optional structure of a pooling dimension raising layer 810 and a fused dimension raising layer 820.

In general, a backbone network of the target detection model provided in this embodiment is composed of a dimension reduction part and a dimension raising part, on the basis of the backbone network, an additional structure such as a non-maximum value suppression layer may also be added.

The number of the dimension reduction layers of the dimension reduction part may be relevant with the size of the target image to be detected. As for a target image to be detected with a larger size, more dimension reduction layers may be arranged to extract features better. Otherwise, for the target image to be detected with a smaller size, fewer dimension reduction layers may be arranged to ensure an effectiveness of the extracted features.

Correspondingly, dimension raising layers having the same number as the dimension reduction layers are provided in this embodiment, which may be used to provide feature map outputs of different sizes, thereby obtaining target detection results of different sizes. In other alternative embodiments, the number of the dimension raising layers and the number of dimension reduction layers may also be different.

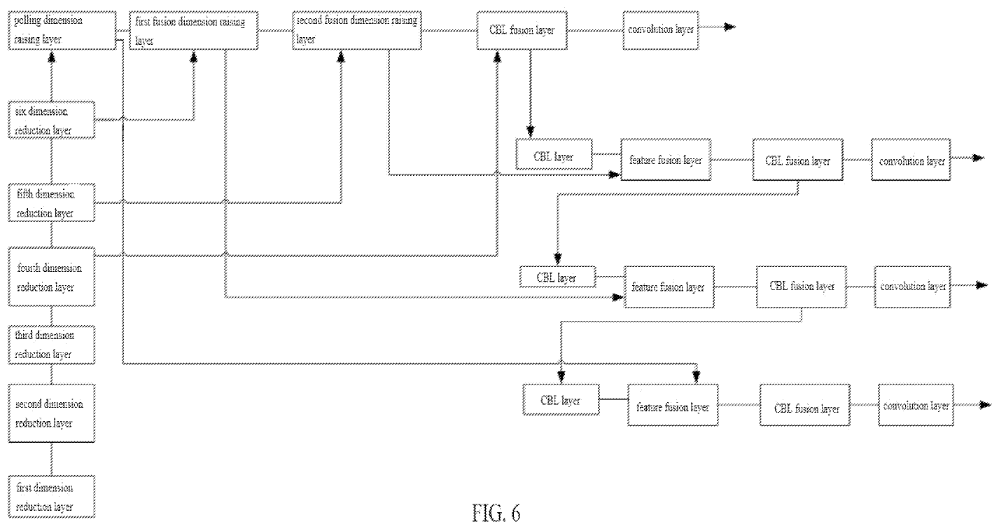

Referring to FIG. 6, a more specific target detection model example is provided below by taking a preset size of 640*640*3 (where, * represents multiplication and is used for indicating a dimension size of an image or a feature map) of the target image as an example.

For the target image to be detected having the size of 640*640*3, feature maps having sizes of 320*320, 160*160, 80*80, 40*40, 20*20 and 10*10 can be obtained by performing dimension reduction in sequence. Thus, in the solution of FIG. 6, the number of the dimension reduction layers is arranged to be 6 (N=6), and the first reduction layer, the second reduction layer, the third reduction layer, the fourth reduction layer, the fifth reduction layer and the sixth dimension reduction layer sequentially perform down-sampling and feature extraction on the image to be detected to obtain the feature maps of the sizes respectively.

It should be noted that, a smaller feature map may also be obtained by additionally increasing the dimension reduction layer into the 10*10 feature map. However, considering the balance of the accuracy and the speed of the model, FIG. 6 illustrates a preferable solution which does not constitute as a limitation to the protection scope of the present application.

Furthermore, in the target detection model shown in FIG. 6, a dimension raising part including a dimension raising layer is provided. It should be noted that, although the term of dimension raising layer and dimension raising part is used for limitation, the “dimension raising” is described with respect to the dimension reduction part (which is used for dimension reduction and feature extraction), the specific model structure (including the dimension raising layer) in the dimension raising part is not limited to the dimension raising of the feature map, and may also include functions such as output, fusion, pooling, and the like.

In particular, in the dimension raising part shown in FIG. 6, the functions and the arrangement of the first fusion dimension raising layer 820 and the second fusion dimension raising layer 820 (i.e., the fusion dimension raising layer 820 serves as the second dimension raising layer and the third dimension raising layer) are better matched with the original meaning of the term of “dimension raising layer”, and the pooling dimension raising layer 810 (and the first dimension raising layer) adds a pooling function on the basis of the original meaning of the term of “dimension raising layer”, and serves as a structure directly connected to the dimension raising part and the dimension reduction part.

After the second dimension layer, a first dimension layer (i.e. the fourth dimension raising layer) composed of the CBL fusion layer and the convolutional layer is arranged for output, which is slightly different from the output layer (i.e. the output layer composed of the CBL layer, the feature fusion layer, the CBL fusion layer, and the convolutional layer) arranged at the back end of the target detection model structurally. The two structures can be used to output feature maps with specified sizes. The target detection model shown in FIG. 6 has an output layer composed of the CBL fusion layer and the convolution layer arranged at the fourth dimension raising layer, and an output layer composed of the CBL layer, the feature fusion layer, the CBL fusion layer, and the convolution layer are arranged at the subsequent fifth dimension raising layer and the sixth dimension raising layer. During the actual implementation of the solution of the present application, the specific position and the number of the two dimension raising layers can be arranged according to the actual requirement.

As described above, as for the target image to be detected having the size of 640*640*3, in the target detection model in FIG. 6, the sixth dimension reduction layer outputs the feature map having the size of 10*10. Then, the feature map having the size of 20*20, 40*40 and 80*80 can be obtained in sequence through dimension raising of the first dimension raising layer, the second dimension raising layer and the third dimension raising layer.

The fourth dimension raising layer can output the feature map having the size of 80*80 obtained by the third dimension raising layer, so as to obtain a target detection result having a size of 80*80.

Generally, the target detection result is a part of the target image to be detected. Thus, a size of the output target detection result is generally smaller than the size of the target image to be detected. Thus, in one preferable embodiment, the sum of the number of the pooling dimension raising layer 810 and the number of the fusion rising dimension layer 820 is smaller than the number of the dimension reduction layers. Otherwise, the size of the output target detection result may be greater than the size of the target image to be detected (unless the subsequent dimension reduction is performed subsequently).

Furthermore, the sixth dimension raising layer can perform dimension reduction on the feature map having the size of 80*80 and output the feature map to obtain a target detection results having the size of 40*40 and 20*20.

At this point, three target detection results (the sizes are 80, 40 and 20 respectively) can be output by the dimension raising part including six dimension raising layers. However, under some conditions, the target to be recognized occupies a small proportion in the target image to be detected, and an output image having the size of 20*20 may be too large for this target. In this case, a dimension raising layer (an output layer) may be additionally provided behind the sixth dimension raising layer, so as to obtain a target detection result having a size of 10*10.

That is, in one optional implementation mode, the number of the dimension raising layers is different from that of the dimension reduction layers.

A feature fusion manner of the target detection model shown in FIG. 6 (ignoring the seventh dimension raising layer, and considering the first six dimension raising layers) are described below.

A feature fusion data source of the first dimension raising layer is a feature map output by the sixth dimension reduction layer.

The feature fusion data source of the second dimension raising layer is the feature map output by the sixth dimension reduction layer and the feature map output by the first dimension raising layer (i+j=6+1=7=N+1).

The feature fusion data source of the third dimension raising layer is the feature map output by the fifth dimension reduction layer and the feature map output by the second dimension raising layer (i+j=5+2=7=N+1).

The feature fusion data source of the fourth dimension raising layer is the feature map output by the fourth dimension reduction layer and the feature map output by the third dimension raising layer (i+j=4+3=7=N+1).

The feature fusion data source of the fifth dimension raising layer is the feature map output by the third dimension raising layer and the feature map output by the fourth dimension raising layer (k+L=3+4=7=N+1).

The feature fusion data source of the sixth dimension raising layer is the feature map output by the second dimension raising layer and the feature map output by the fifth dimension raising layer (k+L=2+5=7=N+1).

It can be seen that in the example of FIG. 6, the first specified range is 4, 5 and 6, the second specified range is 2, 3 (or 4, 5).

Furthermore, in one preferable implementation mode of this embodiment, more specific model structures and relevant descriptions are provided below.

In this embodiment, the main idea of establishing of the model is to decouple training with reasoning. In the training process, the network structure of the model is a multi-branch structure. When the training is completed and the reasoning stage is entered, the overall network structure is converted equivalently into one single-branch structure for deployment and reasoning through structural re-parameterization.

The beneficial effects of this embodiment lie in:
a lightweight target detection model having better execution efficiency and being adaptive to a hardware structure based on the controller 110 and the coprocessor 120 is provided.

One preferable embodiment is provided on the basis of the above-mentioned model architecture. This embodiment will be described from the perspective of the structure of the target detection model and the training manner.

First, an initial model structure is introduced.

The dimension reduction part of the initial model is composed of six dimension reduction layers, a composition unit of the dimension reduction layer includes a first down-sampling structure 211 and a first feature extraction structure 212. The first down-sampling structure 211 includes two first-type branches connected in parallel, the parallel connection means that an input of the first down-sampling structure 211 is simultaneously provided to two first-type branches, and outputs of the two first-type branches (i.e., the output of the convolutional layer is calculated by the BN layer) is summarized to the activation function layer 230, and the output of the activation function layer 230 is the output of the first down-sampling structure 211. Correspondingly, the first feature extraction structure 212 includes two first-type branches connected in parallel, moreover, the first feature extraction structure 212 and one of the second-type branches are further connected in parallel. The aforesaid parallel connection means that the input of the first feature extraction structure 212 are simultaneously provided to two said first-type branches and one said second-type branch, the outputs (i.e., the output of the convolutional layer calculated through the BN layer) of the two first-type branches and the output of the second-type branch (i.e., the direct-connection branch) are summarized as the output of the first feature extraction structure 212.

On this basis, the first dimension reduction layer of the initial model is composed of one first down-sampling structure 211, the second dimension reduction layer is composed of one first down-sampling structure 211 and two first feature extraction structures 212 in sequence, the structures of the third dimension reduction layer, the fifth dimension reduction layer and the sixth dimension reduction layer are consistent with the second dimension reduction layer. The fourth dimension reduction layer is composed of one first down-sampling structure 211 and three first feature extraction structures 212 in sequence.

That is, the dimension reduction part of the target detection model provided in this embodiment may be interpreted as sequentially performing 6 times of down-sampling on the input feature map by the first down-sampling structure 211, excepting the first down-sampling structure 211, adding the first feature extraction structure 212 after each down-sampling, so as to extract image features with different sizes. In the solution provided in this embodiment, the depth of the first feature extraction structure 212 is 0, 2, 2, 3, 2, and 2, respectively.

Taking an output image with a size of 640*640(*3) as an example, the first dimension reduction layer can perform dimension reduction on the output image to obtain a feature map with a size of 320*320, the second dimension reduction layer can continue to perform dimension reduction on the feature map to obtain a feature map with a size of 160*160, and the like, until the sixth dimension reduction layer outputs a feature map with a size of 10*10, which is taken as the output of the dimension reduction part. It is worth noting that, the feature map with the size of 10*10 is the output obtained by the six dimension reduction layers by performing dimension reduction in sequence, and can be directly taken as input data of a subsequent portion (dimension raising part) of the model. However, the feature map with the size of 10*10 is not the unique output of the dimension reduction part, the outputs of the various dimension reduction layers (in some conditions, said outputs can be interpreted as “intermediate result” of the feature map) can also be used as fusion input data of some specific structures of the dimension raising part, this part is described in detail subsequently in the introduction of the dimension reduction part.

It should be noted that, the above descriptions is based on the initial model before the training is completed, and the architecture of the target detection model after the training is completed is slightly different from the aforementioned descriptions, and this part will be described in detail subsequently with respect to the trained part.

In the initial model provided in this embodiment, the dimension raising part is composed of seven dimension raising layers. The composition unit of the dimension raising layer includes a pooling layer, a CBL layer, an upper-sampling layer, a CBL fusion layer, and a feature fusion layer.

It should be noted that, the CBL fusion layer may be interpreted as a fusion layer of multi-CBL calculation which includes a first CBL branch and a second CBL branch connected in parallel, and a CBL fusion output structure. The parallel connection indicates that an input of the CBL fusion layer is simultaneously provided to the first CBL branch and the second CBL branch, and outputs of the first CBL branch and the second CBL branch are summarized to serve as input and output of the CBL fusion output structure, and an output of the CBL fusion output structure is an output of the CBL fusion layer.

Furthermore, the first CBL branch and the second CBL branch are composed of different numbers of CBL sub-layers connected in sequence. For example, the first CBL branch is composed of three CBL sub-layers, and the second CBL branch is composed of two CBL sub-layers. The CBL fusion output structure includes a feature fusion sublayer and a CBL sublayer connected in sequence.

From the perspective of arithmetic operation, the arithmetic operations of the CBL sublayer and the CBL layer may be the same. Similarly, the arithmetic operations of the feature fusion sublayer and the feature fusion layer may also be the same.

It can be understood that, the CBL fusion layer is equivalent to performing fusion (i.e., feature fusion sub-layer) on the features subjected to different times of CBL operations (i.e., feature fusion sub-layers), the extraction of features of different depths is facilitated, and a better output result is obtained.

On this basis, in the initial model provided in this embodiment, the first dimension raising layer is a pooling dimension raising layer 810 composed of a pooling layer, a CBL layer and an upper-sampling layer which are connected in sequence; the second dimension raising layer and the third dimension raising layer are fusion dimension raising layers composed of a CBL fusion layer, a CBL layer and an upper-sampling layer which are connected in sequence; the fourth dimension raising layer is an output layer composed of a feature fusion layer, a CBL fusion layer and a convolution layer which are connected in sequence. The fifth dimension raising layer, the sixth dimension raising layer and the seventh dimension raising layer are output layers composed of a CBL layer, a feature fusion layer, a CBL fusion layer and a convolution layer which are connected in sequence.

Different from the dimension reduction part of the initial model, the structure of the dimension raising part in this embodiment does not change before and after training. That is, although the operation parameters of the dimension raising part are updated in the training process, the arithmetic architectures of the initial model and the trained target detection model are consistent.

As for the initial model, a feature map with the size of 10*10, which is output by the dimension reduction part, is used as the input data of the first dimension raising layer. Then, the second dimension raising layer, the third dimension raising layer, the fourth dimension raising layer, the fifth dimension raising layer, the sixth dimension raising layer and the seventh dimension raising layer perform data operation in sequence, and an output data of a m-th dimension raising layer is input and output of a (m+1)th dimension raising layer.

In particular, in one preferable solution of this embodiment, starting from the fourth dimension raising layer (i.e., for all output layers), an output of the convolutional layer is a target detection result output by this layer. Moreover, an input of the convolutional layer (i.e., the output of the CBL fusion layer) is used as an input of the next dimension raising layer (or the output layer).

Furthermore, in addition to the feature map with the size of 10*10, which is finally output by the dimension reduction part, the dimension raising part further extracts some intermediate results of the dimension reduction part as a basis for feature fusion. The specific extraction solution is as follows:
the input data of the feature fusion layer of the second dimension raising layer includes output data of the first dimension raising layer, and further includes output data of the fifth dimension reduction layer;
the input data of the feature fusion layer of the third dimension raising layer includes output data of the second dimension raising layer, and further includes output data of the fourth dimension reduction layer;
the input data of the feature fusion layer of the fourth dimension raising layer includes output data of the third dimension raising layer, and further includes output data of the third dimension reduction layer.
the input data of the feature fusion layer of the fifth dimension raising layer includes output data of the fourth dimension raising layer (where the output data of the CBL fusion layer of the fourth dimension raising layer may be one of the input data of the feature fusion layer of the fifth dimension raising layer), and further includes output data of the CBL layer of the third dimension raising layer;
the input data of the feature fusion layer of the sixth dimension raising layer includes output data of the fifth dimension raising layer (where the output data of the CBL fusion layer of the fifth dimension raising layer may be one of the input data of the feature fusion layer of the sixth dimension raising layer), and further includes output data of the CBL layer of the second dimension raising layer.
the input data of the feature fusion layer of the seventh dimension raising layer includes output data of the sixth dimension raising layer (where the output data of the CBL fusion layer of the sixth dimension raising layer may be one of the input data of the feature fusion layer of the seventh dimension raising layer), and further includes output data of the CBL layer of the first dimension raising layer.

In the initial model constructed by utilizing the aforesaid architecture, the feature map with the size of 10*10 is raised to the size of 20*20 by the first dimension raising layer, the feature map with the size of 20*20 is raised to the size of 40*40 by the second dimension raising layer, and the feature map with the size of 40*40 is raised to the size of 80*80 by the third dimension raising layer.

Subsequently, the fourth dimension raising layer performs an arithmetic operation by using the feature map with the size of 80*80 and outputs a target detection result of a size of 80*80. Similarly, although the subsequent output layer is a dimension raising layer, the size of the feature map and the size of the target detection result are not raised actually.

Furthermore, the fifth dimension raising layer, the sixth dimension raising layer, and the seventh dimension raising layer use the feature maps with the size of 80*80, the size of 40*40, and the size of 20*20 to perform arithmetic operations in sequence, and output target detection results of the size of 40*40, the size of 20*20 and the size of 10*10.

That is, in the solution provided in this embodiment, in the output part of the target detection model (which may be interpreted as the set of output layers in the dimension raising part), in order to make full use of multi-size information of the backbone network, four feature maps with the sizes of 80×80, 40×40, 20×20, and 10×10 are designed and output.

Furthermore, in this embodiment, the activation function may use a ReLU function.

It can be seen that, the sizes of the input feature maps of the fifth dimension-raising layer, the sixth dimension-raising layer and the seventh dimension-raising layer are different from the size of the output target detection result. That is, the structure similar to the fourth dimension-raising layer can be utilized to obtain the target detection result having the same size as the input feature map, and the target detection result after dimension reduction of the input feature map can also be obtained by using the structure similar to the fifth dimension-raising layer, the sixth dimension-raising layer and the seventh dimension-raising layer.

According to any one of the aforesaid embodiments, one embodiment for training process of the target detection model is provided below, in this embodiment:

The coprocessor 120 further includes a cooperative controller 122, and the cooperative controller 122 may be configured to: perform a training operation of the initial model according to an instruction sent by the controller 110 to obtain a training result, and transmit the training result to the controller 110.

The controller 110 can be further configured to:
update parameters of the initial model according to the training result to obtain a trained initial model; and
fuse arithmetic operation of the convolutional layer and the arithmetic operation of the normalization layer of the first type of branches in the trained initial model to obtain a fused branch.

The controller 110 can be further configured to:
adjust the convolution kernel of the fused branch in the first down-sampling structure 211 of the trained initial model to be the same size in a first preset manner; and/or
adjust the fused branch and the second-type branch in the first feature extraction structure 212 of the trained initial model to be a convolution structure having a same convolution kernel size in a second preset manner.

In this embodiment, data control is performed by the controller 110 in the training process, the coprocessor 120 performs data operation, and the controller 110 receives an arithmetic operation result to perform back propagation of the parameters until the training is completed, and the target detection model with the appropriate model weight parameters is obtained.

The steps of fusion of branches introduced in the aforesaid embodiments may also be performed by the controller 110.

Therefore, the trained model weight parameters are stored in the controller 110, before actual reasoning, the controller 110 can send the model weight parameters to the coprocessor 120 for performing the arithmetic operation in the reasoning process.

In this embodiment, the actuating logic of the training process is similar to the reasoning process. Thus, unless there is special explanation, the implementation of the functions such as computing control and data read/write in the training process can refer to the descriptions about the reasoning part in the aforesaid embodiments.

After the training process, a step of fusion of branches is further included. That is, although the parameters in the initial model have been updated through the training process, the model structure thereof is still a multi-branch structure in the initial model, in this case, the first-type branch and/or the second-type branch after parameter updating need to be fused, then, equivalent fused branches are obtained. Thus, the computation power required during reasoning of the target detection model is reduced.

Still taking the initial model structure provided in the last embodiment as an example, the fusion process is described below.

According to a linear additive property of the convolution operation, it can be seen that the calculation of any first feature extraction structure 212 may be represented as a formula 1, which is expressed as:

$$Out ( x ) = F ( x ) + G ( x ) + x$$

Similarly, the calculation of any first down-sampling structure 211 may be represented as a formula 2, which is expressed as:

$$Out ( x ) = F ( x ) + G ( x )$$

In the formula, F(x) represents 3×3 convolution; G(x) represents 1×1 convolution, X is an input, and Out(x) is an output.

During the reasoning process, the convolutional layer and the BN layer are fused, where, the convolutional layer may be represented as a formula 3, which is expressed as:

$$Conv ( x ) = W ( x ) + b$$

The formula of the BN layer may be represented as a formula 4:

$$B N ( x ) = γ \cdot \frac{x - mean}{\sqrt{var}} + β$$

In this formula, W represents a weight, b represents an offset, and x represents an input; var and mean represent a standard deviation and a mean value respectively, which are obtained through statistics in the training process, γ, β are obtained in training and leaning, Conv represents an output of the convolutional layer, BN represents an output of the BN layer, and x represents an input.

A result expression of the convolutional layer 3 is substituted into the formula 4 to obtain a formula 5:

$$B N ( Conv ( x ) ) = γ \cdot \frac{W ( x ) + b - mean}{\sqrt{var}} + β = \frac{γ \cdot W ( x )}{\sqrt{var}} + ( \frac{γ \cdot ( b - mean )}{\sqrt{var}} + β )$$

Furthermore,

$${W}_{fused} = \frac{γ \cdot W ( x )}{\sqrt{var}} , {B}_{fused} = \frac{γ \cdot ( b - mean )}{\sqrt{var}} + β ,$$

the formula 5 may be converted into a formula 6,

$$B N ( Conv ( x ) ) = {W}_{fused} + {B}_{fused}$$

That is, after the convolution layer and the BN layer are fused, a 3×3 convolution, a 1×1 convolution branch, an identity branch (i.e., the direct connection branch) and three bias vectors may be obtained.

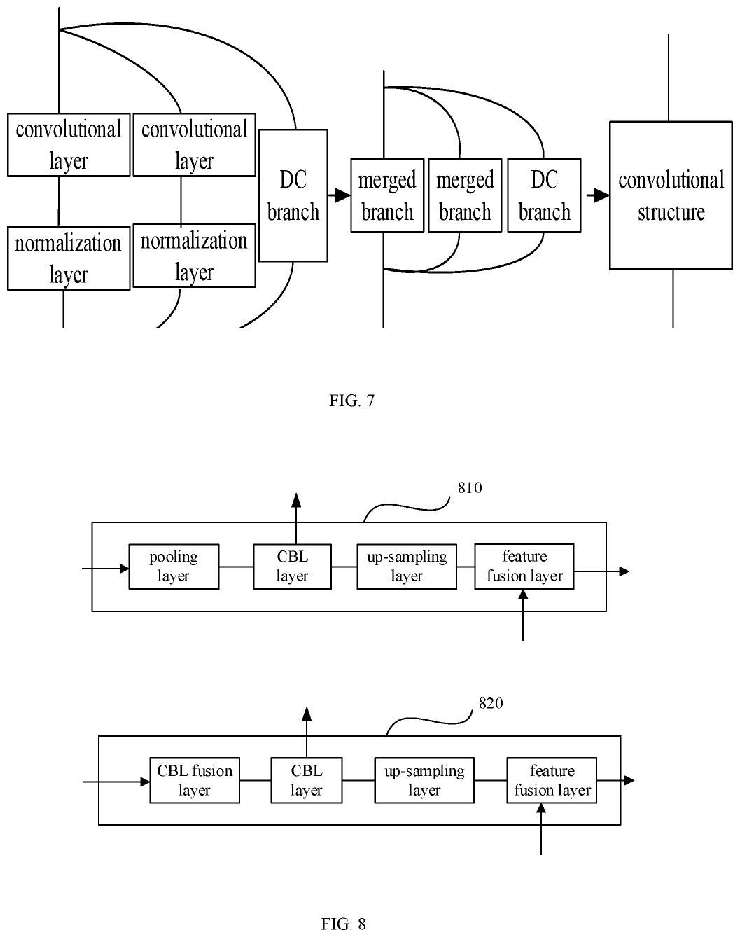

Referring to FIG. 7, the left side of FIG. 7 depicts a branch structure during training, the middle of FIG. 7 depicts a branch equivalent structure after training after branch fusion (or called as structure reparameterization), and the right side of FIG. 7 depicts an actual branch structure in the reasoning process.

Referring to FIG. 7, due to the adoption of the model architecture in the last embodiment, the branch structure (at the left side in FIG. 7) during training is composed of a 1×1 convolution branch, a 3×3 convolution branch, and an Identity branch.

After the training is completed, re-parameterization of the model structure is fused during deploying of reasoning. In particular:

For a 1×1 branch, if the sizes of the input feature map and the output feature map are the same, the convolution stride is 1, the convolution kernel with the size of 1×1 performs a convolution computation on the input image, and output feature maps with the same size can be obtained. The prerequisite of fusion is that the sizes of the feature maps obtained by the various convolution kernels are the same, if it is desirable to convert a convolution kernel with the size of 1×1 into a convolution kernel with the size of 3×3, a pixel with a weight of 1 may be filled on the convolution kernel with the size of 1×1 to convert this convolution kernel into the convolution kernel with the size of 3×3.

Similarly, as for the Identity branch, the Identity branch also needs to be constructed as the output feature map having the same size as the output size of the convolution kernel with the size of 3×3, before it is fused. Thus, in order to ensure that the original weights remain unchanged before and after the Identity branch, the convolution kernel with the size of 3×3 and having weights of 1 and 0 may be selected to perform sub-channel convolution, the current channel convolution kernel weight is arranged to be 1, the weight of other channels is arranged to be 0, the results of the various channels are added after convolution computation, and the fused weight is obtained finally.

Furthermore, the three constructed branches can form 3×3 independent reasoning branch through structural re-parameterization fusion, not only the amount of calculation is reduced, unnecessary video memory occupation during reasoning is also reduced.

It can be understood that the first down-sampling structure 211 is converted into the second down-sampling structure after the aforesaid fusion. Correspondingly, the first feature extraction structure 212 is converted into the second feature extraction structure after the fusion.

In the implementation mode shown in FIG. 7, a network structure during training and a network structure during reasoning are decoupled through the structural re-parameterization fusion, two different structures are formed, a multi-branch structure is formed during training, a single-branch structure is formed during reasoning. However, the single-branch network retains the capability of feature extraction of the multi-branch network.

In the aspect of memory occupation, the multi-branch network (i.e., at least a part of the target detection model) needs to store the calculation results of the branches temporarily, the memory occupation is more than that of the single-branch network. In reverse, the fused reasoning model can achieve an effect similar to that of the multi-branch structure with less computing resource requirement.

The beneficial effects of this embodiment lie in:

A training control logic similar to the reasoning process is provided, thus, the execution codes of the target detection model operating in hardware including the coprocessor 120 and controller 110 has high overlap with the execution codes of the initial model training in hardware including the coprocessor 120 and controller 110, additional cost at the level of execution codes is reduced.

According to any one of the aforesaid embodiments, one embodiment including implementation of specific function of a post-processing subunit is provided below. In this embodiment:

An arithmetic unit 123 includes a post-processing subunit, the post-processing subunit includes a standby arithmetic component. The standby arithmetic component may be configured to perform a specified arithmetic task of non-convolution computation and non-activation function computation.

The post-processing subunit is composed of the following components, including:
a first component configured for converting an integer into a floating-point number;
a second component configured for converting the floating-point number into an integer;
a third component configured for performing a floating-point multiply-add arithmetic operation; and
a fourth component configured for performing an arithmetic operation of the activation function layer 230.

Unlike the direct sub-unit and the convolution sub-unit, the post-processing sub-unit realizes more functions in this embodiment. These functions include the arithmetic operation of normalization (i.e., the batch normalization layer/BN layer), the arithmetic operation of the activation function layer 230, and other specified arithmetic operations.

In this embodiment, the post-processing subunit is used as an executive subject of the following arithmetic operations:
Arithmetic operation of the normalization layer;
Arithmetic operation of the activation function layer 230;
Specified arithmetic task of non-convolution computation and non-activation function computation.

That is, the post-processing subunit is responsible for some specified arithmetic tasks in the coprocessor 120, and these specified arithmetic tasks may be interpreted as the arithmetic tasks without providing specialized arithmetic unit 123 (e.g., the convolution unit). Thus, the computation power thereof is more comprehensive with respect to other specialized unit. The first component, the second component, the third component and the fourth component provided in this embodiment can perform an integer operation, a conversion between floating points, and a multiplication and addition operation of the floating point number, which is a more universal operation structure.

Moreover, the fourth component may be interpreted as hardware composition exclusively used for the arithmetic operation of the activation function.

Embodiments including specific hardware composition will be provided below.

For a lightweight target detection network deployed at an edge end, this embodiment provides a neural coprocessor 120 (Neural Coprocessor, NCP, the NCP may be interpreted as the coprocessor 120 in the aforesaid embodiments). The NCP may be interconnected with a microprogrammed control unit (MCU) provided with a CPU chip (i.e., one preferable embodiment of the controller 110 in the aforesaid embodiments), all functions and weights are stored in the chip by the whole operating system, delay and power consumption in accessing of off-chip memory are completely eliminated.

In particular, both the NCP and the MCU are used as AI chip, and the entire hardware system architecture is described below.

The single NCP neural coprocessor 120 and the MCU are integrated on one compact circuit board to process the target detection task cooperatively.

The MCU may be provided with a Flash memory, a CPU, an input and output (I/O) interface, and a random access memory (RAM). In one optional implementation mode, the MCU is further provided with a sensor 130 interface for receiving a signal of the sensor 130 as an input image.

The MCU communicates with an I/O interface of the NCP through the I/O interface, this signal channel is used to transmit model parameters, image information or a feature map.

The MCU sends model weights and instructions to the NCP before reasoning, NCP has sufficient on-chip SRAM to cache all these data. In the reasoning process, the NCP performs dense CNN backbone workload, and the MCU only performs light load preprocessing (color normalization) and post-processing (full connection layer, non-maximum suppression, etc.).

Considering the requirement of real-time communication, the SDIO serial peripheral interface (SPI) is used to interconnect the NCP with the MCU. Since the interface is mainly used for frequently transmitting an input image and an output result, bandwidths of SDIO and SPI are sufficient to perform real-time data transmission. For example, SDIO may provide a bandwidth up to 500 Mbps (Million bits per second, Mbps), 300 frames per second (Frame Per Second, FPS) may be transmitted for 256×256×3 images, and 1200 frames per second may be transmitted for 128×128×3 images. For a relatively slower serial periphery interface (SPI), 100 Mbps can still be reached, or an equivalent throughput of 256×256×3 images is 60 frames per second.

According to any one of the aforesaid embodiments, in another embodiment:

A tensor memory 124 includes:
an input buffer portion having a storage space matching with the target image to be detected;
a feature cache portion having a storage space matching with a feature map tensor, and the feature map tensor is at least a portion of output data of any dimension reduction layer or any dimension raising layer of the target detection model;
a weight buffer portion having storage space matching with model weight parameters of the target detection model; and
an output buffer portion having a storage space matching with the target detection result with a specified size.

The cooperative controller 122 may be further configured to: store, according to calculation result form information in instruction decoding information, a second result calculated by the arithmetic unit 123 according to the instruction decoding information to the tensor memory 124 in a preset manner. The preset manner corresponds to the calculation result form information in a one-to-one correspondence manner.

Said storing the second result calculated by the arithmetic unit 123 in the tensor memory 124 in the preset manner according to the calculation result form information in the instruction decoding information according to the instruction decoding information, includes:
when determining that the calculation result form information in the instruction decoding information is a two-dimensional tensor, storing the second results in the two-dimensional tensor form and calculated by the arithmetic unit 123 according to the instruction decoding information sequentially in the tensor memory 124 according to the sequence of channels, and the data of any channel is stored in the tensor memory 124 according to a row major order or a column major order.

Said storing the second result calculated by the arithmetic unit 123 in the tensor memory 124 in the preset manner according to the calculation result form information in the instruction decoding information according to the instruction decoding information, includes:

Determining the calculation result form information in the instruction decoding information as a three-dimensional tensor, and storing the second result in the three-dimensional tensor form calculated by the arithmetic unit 123 according to the instruction decoding information in specified three-dimensional storage blocks of the tensor memory 124.

The three-dimensional storage blocks are a plurality of preset storage blocks in the tensor memory 124, a storage space of any one of the three-dimensional storage blocks matches with a size of three-dimensional feature map of the target detection model, and a storage address of any bit in the three-dimensional storage block corresponds to a channel serial number, a tile serial number, and an in-tile row and column number of a second result in the three-dimensional tensor form.

That is, this embodiment provides a specific architecture and storage/operation mode of the coprocessor 120, and on the basis of the AI chip of the NCP and the MCU in the previous embodiment, the solution of this embodiment may be implemented in the following preferred manner:

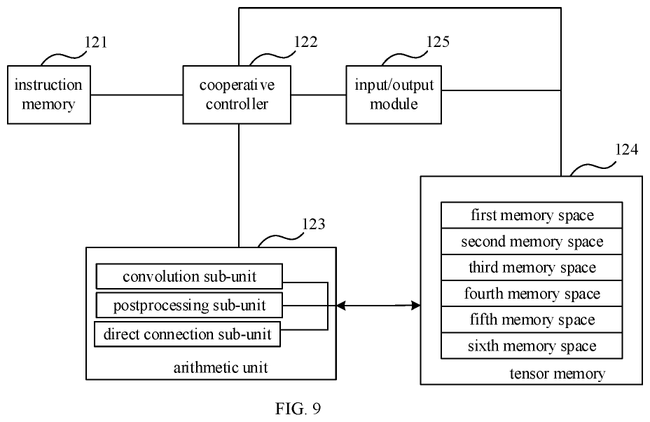

As shown in FIG. 9, the NCP is composed of five main components of a tensor memory 124 (TM), an instruction memory 121 (IM), an input/output module 125 (I/O), an arithmetic unit 123 (or referred to as a neural arithmetic unit 123, NOU), a cooperative controller 122, (or referred to as a system controller, SC). When the NCP is operated, the SC decodes an instruction obtained from the IM first, and notifies the NOU to start computation using the decoded signal. The computation process requires multiple cycles, during this period, the NOU reads operand from the TM and automatically writes back the result. Once a write back process is completed, the SC will continue to process the next instruction until an end instruction or a suspend instruction is received. When the NOU is idle, TM may be accessed through I/O. Each of the components will be described below in the following parts.

First, the neural arithmetic unit 123 is introduced.

NOU includes three sub-modules which are referred to as NOU-CONV (convolution sub-unit), NOU-IDT (direct sub-unit), and NOU-POST (post-processing sub-unit), which are respectively used for supporting corresponding neural operations of conv, Identity, and bn.

NOU-conv processes 3×3 convolution and 1×1 convolution in the target detection model backbone network. The input feature map (IF) and the kernel (KL) are firstly converted into a matrix through an im2col operation (i.e., expanding the input feature map transversely to arithmetic operation of 1 column, expanding the convolution kennel to arithmetic operation of 1 column); then, T_{oc}×T_{hw} 8-bit MAC array is used to perform matrix multiply-accumulation arithmetic operation to achieve convolution.

In particular, T_{oc} represents the number of slices along channel dimension, for example, T_{oc}=16 represents dividing the input feature map into 16 slices along the channel dimension, and each slice has a height and a width. T_{hw} represents the height and the width of each slice. A slicing operation is an operation performed after obtaining the feature map through the first down-sampling structure 211 or the first feature extraction structure 212 and belongs to an intermediate step of the target detection model. The slicing operation is not a feature map similar to 80×80×255, and the specific value may be arranged according to the requirement.

In this embodiment, the 8-bit MAC array refers to a matrix composed of a plurality of 8-bit multipliers. Experiments prove that in this embodiment, the use of 8-bit hardware can ensure that a balance between the current computation efficiency and the computation precision is reached, a 4-bit MAC array can reduce the computation precision, and the 16-bit MAC array can reduce the calculation efficiency.

The NOU-Idt uses shift registers, multipliers, and an adder tree to perform Identity arithmetic operation in a classical convolution processing pipeline. 9 multipliers and 8 adders are arranged to process the identity in processing of each pipeline. With the assistance of the shift register, each pipeline may store neighborhood pixels and generate a convolution result in each looped output channel. In order to accelerate the convolution calculation, T_{oc} of 2D convolution processing pipeline in the NOU-Idt module are arranged to achieve parallel computing of N_{oc} dimension.

The number of the multipliers and the adders is matched with the example of the target detection model provided in the aforesaid embodiment, the total times of conversion from the second down-sampling structure (or referred to as the first down-sampling structure 211) into the second feature extraction structure (or referred to as the first feature extraction structure 212), or the time of conversion from the second feature extraction structure (or referred to as the first feature extraction structure 212) into the second down-sampling structure (or referred to as the first down-sampling structure 211) is 9. In this condition, an independent convolution kernel needs to be performed on each channel of the input feature map. Thus, 9 multipliers are provided.

However, 8 adders are arranged in this embodiment, this is because that a point-by-point convolution computation needs to be performed, point-by-point add operation is performed on the weights of the intermediate feature map and different channels. Thus, 8 adders are needed.

The total T_{oc} refers to the total number of processed pipelines in the NOU-Idt module, and may also be interpreted as the number of parallel processing units, which is irrelevant with T_{oc} in the NOU-conv.

N_{oc} represents the dimension of the parallel computation in the NOU-Idt, which may be interpreted as the number of processing units that perform computation simultaneously.

The NOU-post implements BN, ReLU, and element addition operations (the “element addition operation” herein refers to performing addition operations on the elements one by one, and such operations may be addition operations or other element-by-element operations, which depends on application requirement). T_{oc} post-processing unit is used to apply a single-precision floating-point calculation. Each post-processing unit includes an interg2float module (a first component for converting an integer into one single-precision floating-point number), a floating-point MAC (a third component for performing the floating-point multiply-add arithmetic operation), a ReLU Module (a fourth component for implementing a modified linear unit ReLU activation function), and a float2integer module (the second component used for converting the floating-point number into an integer).

The input of the post-processing unit is from NOU-conv, NOU-Idt, or TM selected by a multiplexer. Therefore, the results of calculation of CONV 3×3, CONV 1×1 or Identity can be directly sent to NOU-post, which allows BN, ReLU to be fused with conv and Identity. Thus, the number of accessing times of the memory is greatly reduced.

Furthermore, the tensor memory 124 TM will be described below.

TM is a single-port SRAM consisting of six memory banks with a width of Tₜₘ×8 bits, as shown in FIG. 4. Due to the compactness of the overall network hardware structure, 992 KB on-chip SRAM is only needed by the NCP. BankI (192 KB) is used for caching input color image with the size of 640×640×3. Bank 0 and Bank 1 with the size of 128 KB are used to cache the feature map, and Bank 2 and Bank 3 with the size of 256 KB are used to store model weights. The Bank0 with the size of 32 KB is used to store calculation results, such as feature vectors, heat maps, junction boxes, and the like. The small capacity and simple structure of TM enables small space occupation of NCP.

Regarding the layout of tensor, in order to improve memory accessing efficiency and parallelism of processing, a pixel main layout and a staggered layout are specially designed.

As for the pixel main layout, all pixels of the first channel are sequentially mapped to the TM in a row major order. Next, the next channel is arranged in the same manner until all channels in the tensor are stored. The pixel master layout is convenient for the operation of obtaining continuous column data in one memory access, but is inefficient for those operations that need to access continuous channel data in one cycle. In this condition, the tensor is converted into a staggered layout by using move instruction. In this layout, the entire tensor is divided into N_{c}//Tₜₘ tiles and is placed in an order of TM, while each tile is arranged in the master order of channels. With the two tensor layouts, the NCP can effectively utilize the bandwidth of TM to reduce the memory access delay greatly.

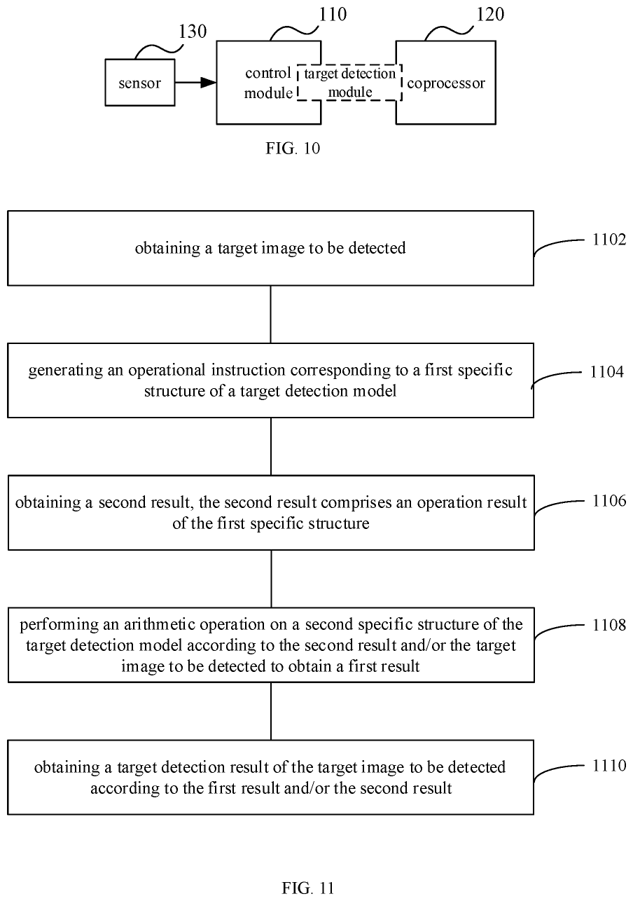

Furthermore, FIG. 10 illustrates a system for target detection architecture including a sensor 130 for inputting image, as shown in FIG. 10, the system for target detection further includes an image sensor 130. The image sensor 130 is configured to read the target image to be detected or the sample, and transmit the target image to be detected or the sample to the controller 110.

Corresponding to the aforesaid system embodiments, starting from the perspective of execution methods (in some conditions, these methods may be algorithmized to generate specific program codes to be executed at a predetermined hardware, such as an AI chip), some method embodiments are provided below.

Method for target detection is provided in this embodiment, as shown in FIG. 11, this method is applied to a controller 110, and includes:

At step 1102, a target image to be detected is obtained.

At step 1104, an arithmetic instruction corresponding to a first specified structure of the target detection model is generated. The arithmetic instruction is used to control the coprocessor 120 to perform an arithmetic task of the first specified structure.

At step 1106, a second result is obtained, the second result includes an arithmetic operation result of the first specified structure.

At step 1108, an arithmetic operation of a second specified structure of the target detection model is performed according to the second result and/or the target image to be detected so as to obtain a first result.

At step 1110, a target detection result of the target image to be detected is obtained according to the first result and/or the second result.

The target detection model is a machine learning model obtained by training an initial model according to a sample.

Similar to the aforesaid system embodiments, in this embodiment, the controller 110 can obtain the target image to be detected, and the target image to be detected is input data for target detection. For the system for target detection provided in this embodiment, arithmetic tasks of the target detection model (in some optional embodiments, the target detection model is a neural network model, in these embodiments, the target detection model is also referred to as a target detection network) are implemented on the controller 110 and the coprocessor 120, respectively. Thus, with reference to the example in FIG. 1, it is understood that the target detection model is partially deployed on the controller 110 and partially deployed on the coprocessor 120.

Moreover, the first specified structure and the second specified structure may be interpreted as different work division of the target detection model on the controller 110 and the coprocessor 120. During actual execution, the specific task of the target detection model can be decomposed, and model weight parameters which belong to the same category of arithmetic operation are stored in the specific address, so that the controller 110 and the coprocessor 120 can directly read the model weight parameters from the specific address when performing the specific arithmetic task.

Furthermore, which tasks to be processed by the controller 110 and the coprocessor 120 depend on the specific architecture of the target detection model, the hardware configuration of the controller 110, and the hardware configuration of the coprocessor 120. That is, the arithmetic task of the target detection model performed by the controller 110 matches with the hardware configuration of the controller 110, and the arithmetic task of the target detection model performed by the coprocessor 120 matches with the hardware configuration of the coprocessor 120.

It should be noted that, in this embodiment, the set of the first specified structure and the second specified structure constitutes at least a part of the target detection model, and does not necessarily constitute the complete target detection model. In actual use, in addition to the controller 110 and the coprocessor 120, other calculation units (for calculating the third specified structure of the target detection model) may exist.

However, in one optional implementation mode, the first specified structure and the second specified structure are constituted as the target detection model.

After the step of obtaining the target image to be detected, the method includes:
color normalization is performed on the target image to be detected and the target image to be detected is sent to the coprocessor 120.

By way of example rather than limitation, the controller 110 may be a micro-controller 110 (Micro-Controller Unit; MCU), the coprocessor 120 may be a neural coprocessor 120 (Neural Coprocessor, NCP).

In one example based on MCU, NCP, and the target detection network, the task division of the coprocessor 120 and the controller 110 may be configured to: the NCP performs a dense CNN backbone workload, and the MCU only performs light load preprocessing (e.g., color normalization) and post-processing (e.g., full connection layer, non-maximum suppression, etc.) during a reasoning process.

According to the aforesaid embodiment, in yet another embodiment:

Both the target detection model and the initial model include a dimension reduction part, a dimension raising part and a post-processing part which are connected in sequence.

The dimension reduction part is configured to perform feature extraction on the target image to be detected to obtain a plurality of dimension reduction features. The dimension raising part is configured to perform feature fusion on the dimension reduction features to obtain at least one dimension raising feature; the post-processing part is configured to perform full connection arithmetic operation on the dimension raising features and output the target detection result.

The dimension reduction part of the initial model includes a first sampling module 210, the first sampling module 210 includes at least two convolution branches with different sizes. The dimension reduction part of the target detection model includes a second sampling module 220, and the second sampling module 220 is obtained by fusing the convolution branches of the first sampling module 210.

The training process of the target detection model in this embodiment is described below.

Before the step of obtaining the second result, the method further includes:
generating a training instruction which is used for controlling the coprocessor 120 to perform a sample-based training operation;
obtaining a training result, and updating parameters of the initial model according to the training result so as to obtain a trained initial model, the training result is a result obtained by the coprocessor 120 by performing arithmetic operation according to the training instruction;
fusing the convolutional layer arithmetic operation and the normalization layer arithmetic operation of the convolution branches in the trained initial model to obtain the initial model with fused branches.

After the step of fusing the convolution layer arithmetic operation and the normalization layer arithmetic operation of the convolution branches in the trained initial model to obtain the initial model with the fused branches, the method further includes:
performing the following steps to obtain the target detection model:
adjusting the convolution kernels of the fusing branches to the same size in a first preset manner; and/or
adjusting the fused branches and the direct connection branch to the convolution structures have the same convolution kernel size in a second preset manner.

After the step of obtaining the target detection model, the method further includes:
sending the model weight parameters of the target detection model to the coprocessor 120.

The second specified structure includes a full connection layer and/or a non-maximum suppression layer in the post-processing part of the target detection model.

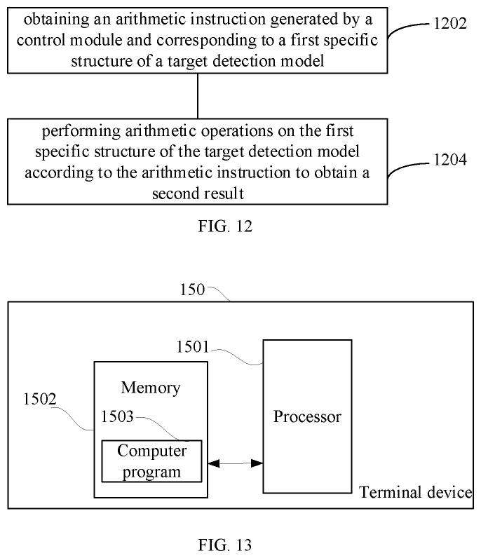

Corresponding to the method embodiment applied to the controller 110, a method for target detection is further provided in the present application. As shown in FIG. 12, the method for target detection is applied to the coprocessor 120, and includes:

At step 1202, an arithmetic instruction corresponding to the first specified structure of the target detection model and generated by the controller 110 is obtained.

At step 1204, arithmetic operations of the first specified structure of the target detection model is performed according to the arithmetic instruction so as to obtain a second result. The second result is used as an input parameter for the controller 110 for performing at least some of the arithmetic operations of the second specified structure of the target detection model; and/or the second result is used as the input parameter to obtain the target detection result of the target image to be detected.

The target detection model is a machine learning model obtained by training the initial model according to a sample.

In one optional implementation mode, the first specified structure and the second specified structure are constituted as the target detection model.

Before the step of obtaining the arithmetic instructions of the first specified structure corresponding to the target detection model and generated by the controller 110, the method further includes:
obtaining a training instruction, and performing a sample-based training operation according to the training instruction to obtain a training result.

Before the step of obtaining the arithmetic instructions of the first specified structure corresponding to the target detection model and generated by the controller 110, the method further includes:
obtaining model weight parameters of the target detection model, the model weight parameter is used to perform an arithmetic operation on the first specified structure of the target detection model.

Both the target detection model and the initial model include a dimension reduction part, a dimension raising part and a post-processing part which are connected in sequence;

The dimension reduction part is configured to perform feature extraction on the target image to be detected to obtain a plurality of dimension reduction features. The dimension raising part is configured to perform feature fusion on the dimension reduction features to obtain at least one dimension raising feature. The post-processing part is configured to perform a full connection arithmetic operation on the dimension raising feature and output the target detection result.

The dimension reduction part of the initial model includes a first sampling module 210. The first sampling module 210 includes at least two convolution branches with different sizes; and the dimension reduction part of the target detection model includes a second sampling module 220, the second sampling module 220 is obtained by fusing the convolution branches of the first sampling module 210.

The first specified structure includes:
a down-sampling layer, a feature extraction layer, a normalization layer, a direct connection branch, and an activation function layer 230 in the dimension raising part of the target detection model; and
a pooling layer, a CBL layer, an upper-sampling layer, a feature fusion layer, and an activation function layer 230 in the dimension reduction part of the target detection model.

The down-sampling layer includes a convolution layer, a normalization layer, and an activation function layer 230. The feature extraction layer includes a convolution layer, a normalization layer, and a direct connection branch.

The step of performing the arithmetic operation of the first specified structure of the target detection model according to the arithmetic instruction so as to obtain the second result includes:
invoking a convolution subunit to perform the arithmetic operation if the arithmetic instruction is determined as the convolution layer arithmetic operation; and
invoking a direct connection subunit to perform the arithmetic operation if the arithmetic instruction is determined as a direct connection branch arithmetic operation;
invoking the post-processing subunit to perform the arithmetic operation if the arithmetic instruction is determined as the arithmetic operation of the normalization layer or the arithmetic operation of the activation function layer 230.

It should be understood that, the values of serial numbers of the steps in the aforesaid embodiments do not indicate an order of execution sequences of the steps; instead, the execution sequences of the steps should be determined by functionalities and internal logic of the steps, and thus shouldn't be regarded as limitation to implementation processes of the embodiments of the present application.

A terminal device 150 is further provided in one embodiment of the present application. As shown in FIG. 13, the terminal device 150 includes: at least one processor 1501, a memory 1502, and a computer program 1503 stored in the memory 1502 and executed by the at least one processor 1501. The processor 1501 is configured to, when executing the computer program 1503, implement steps of the various method embodiments as described above.

A non-transitory computer-readable storage medium is further provided in one embodiment of the present application. The non-transitory computer-readable storage medium store a computer program 1503, that, when executed by the processor 1501, causes the processor 1501 to perform the steps in the various method embodiments.

A computer program product is further provided in one embodiment of the present application. The computer program product is configured to, when being executed on the mobile terminal, causes the mobile terminal to perform the steps in the various method embodiments. The aforesaid embodiments are merely used to illustrate the technical solutions of the present application, and are not intended to limit the technical solutions of the present application. Although the present application has been described in detail with reference to the embodiments described above, the person of ordinary skill in the art should understand that, the technical solutions described in these embodiments can still be modified, or some or all technical features in the embodiments can be equivalently replaced. However, these modifications or replacements do not make the essences of corresponding technical solutions to deviate from the spirit and the scope of the technical solutions of the embodiments of the present application, and thus should all be included in the protection scope of the present application.

What is claimed is:

1. A system for target detection, comprising a controller and a coprocessor, the controller is in communication connection with the coprocessor;
wherein the controller is configured to perform at least some arithmetic operations of a target detection model according to a target image to be detected and/or data sent by the coprocessor so as to obtain one or a plurality of first result(s), each of the first result(s) comprises a data result to be transmitted to the coprocessor;
the coprocessor is configured to perform at least some arithmetic operations of the target detection model according to the target image to be detected and/or data sent from the controller so as to obtain one or a plurality of second result(s), wherein each of the second result(s) comprises a data result to be transmitted to the controller;
wherein the target detection model is a machine learning model obtained by training an initial model according to a sample, there exists at least one data result for obtaining a target detection result of the target image to be detected in the first result(s) and the second result(s).

2. The system for target detection according to claim 1, wherein the initial model comprises a first sampling module configured to extract an image feature, and the first sampling module comprises at least two convolution branches with different sizes; the target detection model comprises a second sampling module, and the second sampling module is obtained by fusing the at least two convolution branches of the first sampling module.

3. The system for target detection according to claim 1, wherein the controller is further configured to transmit arithmetic instructions to the coprocessor; the coprocessor is configured to perform arithmetic operations on instruction parts of the target detection model according to the arithmetic instructions to obtain the second result(s), wherein the arithmetic instructions are in a one-to-one correspondence with the instruction parts of the target detection model.

4. The system for target detection according to claim 3, wherein the coprocessor comprises an instruction memory configured to store the arithmetic instructions.

5. The system for target detection according to claim 3, wherein the second result further comprises a data result used as an input parameter for performing at least some arithmetic operations of the target detection model.

6. The system for target detection according to claim 5, wherein the coprocessor comprises a tensor memory, the tensor memory is configured to store:
a first result in a tensor form and being sent from the controller to the coprocessor; and/or,
a second result in the tensor form and being used for performing at least some arithmetic operations of the target detection model.

7. The system for target detection according to claim 6, wherein the coprocessor further comprises a cooperative controller, and the cooperative controller configured to decode the arithmetic instructions in the instruction memory to obtain instruction decoding information.

8. The system for target detection according to claim 7, wherein the coprocessor further comprises an arithmetic unit, the arithmetic unit is configured to invoke data in the tensor memory as input data, perform arithmetic operations on the instruction parts of the target detection model according to the instruction decoding information to obtain the second result(s), and write the second result(s) into the tensor memory.

9. The system for target detection according to claim 2, wherein each convolution branch comprises a first-type branch, and the first-type branch comprises a convolutional layer and a normalization layer connected in sequence.

10. The system for target detection according to claim 9, wherein the coprocessor comprises an arithmetic unit, and the arithmetic unit comprises a convolution subunit configured to perform an arithmetic operation of the convolution layer in the first-type branch.

11. The system for target detection according to claim 10, wherein the convolution subunit is composed of a plurality of multiply-adder arrays having a preset number that matches with a size of a feature map of the target detection model.

12. The system for target detection according to claim 9, wherein the coprocessor comprises an arithmetic unit, the arithmetic unit comprises a post-processing subunit configured to perform an arithmetic operation of the normalization layer in the first-type branch.

13. The system for target detection according to claim 9, wherein the convolution branch comprises a second-type branch, the second-type branch is a direct connection branch configured to map a value of a direct connection branch input to an output of the direct connection branch.

14. The system for target detection according to claim 13, wherein the coprocessor comprises an arithmetic unit, the arithmetic unit comprises a direct connection subunit configured to perform a direct connection arithmetic operation in the second type of branch.

15. A method for target detection implemented by a coprocessor of a system for target detection, the method comprising:
obtaining an arithmetic instruction generated by a controller and corresponding to a first specific structure of a target detection model; and
performing arithmetic operations on the first specific structure of the target detection model according to the arithmetic instruction so as to obtain a second result; wherein the second result is used as an input parameter utilized by the controller for performing at least some of the arithmetic operations of the second specific structure of the target detection model; and/or the second result is used as an input parameter for obtaining a target detection result of the target image to be detected;
wherein the target detection model is a machine learning model obtained by training an initial model according to a sample.

16. The method for target detection according to claim 15, wherein the first specific structure and the second specific structure are constituted as the target detection model.

17. The method for target detection according to claim 16, wherein before the step of obtaining the arithmetic instruction generated by the controller and corresponding to the first specific structure of the target detection model, the method further comprises:
obtaining an instruction for training, and performing a sample-based training operation according to the instruction for training so as to obtain a training result.

18. The method for target detection according to claim 15, wherein before the step of obtaining the arithmetic instruction generated by the controller and corresponding to the first specific structure of the target detection model, the method further comprises:
obtaining a model weight parameter of the target detection model, wherein the model weight parameter is used for performing an arithmetic operation on the first specific structure of the target detection model.

19. A terminal device, comprising a memory, a processor, and a computer program stored in the memory and executable by the processor, wherein the processor is configured to, when executing the computer program, implement the method for target detection according to claim 1.

20. A non-transitory computer-readable storage medium which stores a computer program, that, when executed by a processor of a terminal device, causes the processor of the terminal device to implement the method for target detection according to claim 1.
